(19) United States
(12) Patent Application Publication
(10) Pub. No.: US 2025/0200832 A1
(43) Pub. Date: Jun. 19, 2025

(54) METHOD AND APPARATUS FOR ASSIGNING AT LEAST ONE HUMAN-PERCEIVED ATTRIBUTE TO A SAMPLE COATING

(71) Applicant: BASF COATINGS GMBH, MUENSTER (DE)

(72) Inventors: Florian STEUFMEHL, Muenster (DE); Guido BISCHOFF, Muenster (DE)

(21) Appl. No.: 18/847,712

(22) PCT Filed: Apr. 21, 2023
(86) PCT No.: PCT/EP23/60388

§ 371 Date: Sep. 17, 2024

(30) Foreign Application Priority Data
Apr. 25, 2022 (EP) 22169734.5

(51) Int. Cl. G06T 11/00; G06F 3/04845

(52) U.S. Cl. CPC G06T 11/001; G06F 3/04845; G06T 2200/24

(57) ABSTRACT

Disclosed herein are a method for assigning at least one human-perceived attribute to a sample coating based on a visual evaluation of the sample coating with respect to a reference coating, and respective apparatuses, or computer elements. Further disclosed herein are methods and respective apparatuses, or computer elements for assigning at least one human-perceived attribute to a sample coating based on a visual evaluation of the sample coating with respect to a reference coating by displaying images of a reference coating modified with respect to the appearance, such as the darkness and/or lightness and/or color and/or texture and/or the gloss and/or the clearcoat appearance, within a user interface.

### FIELD

Aspects described herein generally relate to a method for assigning at least one human-perceived attribute to a sample coating based on a visual evaluation of the sample coating with respect to a reference coating, and respective apparatuses, or computer elements. More specifically, aspects described herein relate to methods and respective apparatuses, or computer elements for assigning at least one human-perceived attribute to a sample coating based on a visual evaluation of the sample coating with respect to a reference coating by displaying images of a reference coating modified with respect to the appearance, such as to the darkness and/or lightness and/or color and/or texture and/or gloss and/or clearcoat appearance, within a user interface. This allows to rate the visually perceived deviation of the sample coating from the reference coating easily and intuitively by comparing the deviation perceived in the physical world by a human observer with images of the modified reference coating displayed within the user interface, thus providing a standardized classification of visually perceived differences in terms of appearance between a sample and a refence coating layer and avoiding the use of wordings and terms being subject to interpretation by the human observer.

### BACKGROUND

Surface coatings such as monocoat, clearcoat/colorcoat, and tricoat are favored for the protection and decoration of substrates such as vehicle bodies. The surface coatings can contain one or more pigments or effect pigments to impart the desired color or appearance, such as solid, metallic, pearlescent effect, gloss, or distinctness of image, to the vehicle bodies. Metallic flakes, such as aluminum flakes are commonly used to produce coatings having flake appearances such as texture, sparkle, glint and glitter as well as the enhancement of depth perception in the coatings imparted by the flakes.

When performing a visual assessment of a color match, the observed deviations are often difficult to describe, especially for untrained people. Such visual comparison is commonly performed during repair processes to select the best matching sample coating material such that the repaired area does not have a visually distinct color from the undamaged area(s). For this purpose, appearance data of undamaged areas may be acquired and may be used in color matching processes to identify best matching sample coating materials. The best match may be selected and may be used to prepare a sample coating. The prepared sample coating may be visually compared to undamaged areas representing the reference (e.g. the reference coating). The directions in which a color deviation is perceived depend on the color class, the chromaticity, the effect, etc. Additionally, the perception and interpretation of color is highly subjective. Eye fatigue, age, the environment in which you are viewing the color and other factors can influence color perception. Ideally, trained people perform a color assessment based on color space values, e.g. CIELab, and terms, e.g. defined color difference formulas. For example, visual differences between chromatic colors are described using chromaticity and hue deviation (=dC, dH) while a difference between the red-green or blue-yellow axis (=da, db) is used for achromatic colors. Nevertheless, each trained observer interprets color based on personal preferences. Each observer also verbally defines an object's color differently. When collecting color match assessments from different observers, this leads to a lack of comparability and limited usability of the cumulated assessments.

It would therefore be desirable to provide a standardized method to visually assess deviations of a sample coating from a reference coating which is not associated with the aforementioned drawbacks. More specifically, there is still a need to provide some type of standardization for the assessment of color deviations to allow comparison of assessments from different observers and to cumulate the collected assessments.

### Definitions

As used herein “determining” also includes “initiating or causing to determine”, “generating”, “querying”, “accessing”, “correlating”, “matching”, “selecting” also includes “initiating or causing to generate, access, query, correlating, select and/or match” and “providing” also includes “initiating or causing to determine, generate, access, query, correlating, select and/or match, send and/or receive”. “Initiating or causing to perform an action” includes any processing signal that triggers a computing node to perform the respective action.

“Appearance” refers to the visual impression of the coated object to the eye of an observer and includes the perception in which the spectral and geometric aspects of a surface is integrated with its illuminating and viewing environment. In general, appearance includes color, visual texture such as coarseness caused by effect pigments, sparkle, or other visual effects of a surface, especially when viewed from varying viewing angles and/or with varying illumination angles. The term “clearcoat appearance” refers to the visual impression of an object coated with at least one clearcoat layer to the eye of the observer. The clearcoat appearance can, for example, be characterized by the presence or absence of orange peel (reflected by shortwave and longwave values) as well as the brilliance and gloss (reflected by DOI or Distinctness of Image values). “Clearcoat layer” refers to a transparent coating layer. “Transparent” means that the coating layer is not fully opaque but instead has a certain degree of transparency that allows the color of the underlying coating layer(s) to be visible through the clearcoat layer. The clearcoat layer may therefore be completely free of pigments, comprise only transparent pigments or comprise amounts of pigments which do not render the clearcoat layer.

“Reference coating” may refer to a coating having defined properties, such as defined colorimetric properties. The reference coating can be prepared by applying at least one defined coating material to a surface and curing said applied coating material. In contrast, the term “sample coating” may refer to a coating that is evaluated in comparison with the reference coating with respect to at least part of the defined properties, such as colorimetric properties. The sample coating can be prepared using a mixing formula or by a mixing ingredients according to a given recipe. Such mixing formula or recipe may be identified based on the reference coating. For instance, appearance data of the reference coating may be used to perform commonly known color matching processes to identify mixing formulae or recipes supposed to result in a sample coating matching the appearance of a reference coating. The term “sample coating formulation” refers to the coating material used to prepare the sample coating while the term “reference coating formulation” refers to the coating material used to prepare the reference coating. The terms “formulation”, “color formulation” and “paint formulation” are used synonymously herein.

“Digital representation” may refer to a representation of the reference coating in a computer readable form. In particular, the digital representation of the reference coating contains appearance data of the reference coating, where the appearance data has been determined at a plurality of measurement geometries. The digital representation of the reference coating may further include the color name, the color number, the color code, a bar code, a QR code, a unique database ID, a mixing formula (i.e. instructions to prepare the coating material associated with the respective coating), color rankings, a price, the layer structure of the coating, the manufacturer of the coating materials used to prepare the reference coating, the manufacturer of the substrate comprising the reference coating, the model comprising the reference coating, the production year of the substrate comprising the reference coating, the car part comprising the reference coating, or a combination thereof.

“Human-perceived attribute” assigned to the sample coating refers to an attribute of a sample coating in relation to a reference coating, such as a difference in the lightness, darkness, texture, color, gloss and/or clearcoat appearance, which is perceived by a human observer, such as a refinisher, upon visually comparing the sample coating to the reference coating.

“Display image” refers to an image content formed on a display. A typical display image is a television broadcast content. The display image will take up all or part of the display.

“Display” refers to the screen of an output device for presentation of information in visual or tactile form (the latter may be used in tactile electronic displays for blind people). The display may include physical displays, projection regions or a combination thereof.

“Communication interface” may refer to a software and/or hardware interface for establishing communication such as transfer or exchange or signals or data. Software interfaces may be e. g. function calls, APIs. Communication interfaces may comprise transceivers and/or receivers. The communication may either be wired, or it may be wireless. Communication interface may be based on or it supports one or more communication protocols. The communication protocol may a wireless protocol, for example: short distance communication protocol such as Bluetooth®, or WiFi, or long distance communication protocol such as cellular or mobile network, for example, second-generation cellular network (“2G”), 3G, 4G, Long-Term Evolution (“LTE”), or 5G. Alternatively, or in addition, the communication interface may even be based on a proprietary short distance or long distance protocol. The communication interface may support any one or more standards and/or proprietary protocols.

“Hardware processor” refers to an arbitrary logic circuitry configured to perform basic operations of a computer or system, and/or, generally, to a device which is configured for performing calculations or logic operations. In particular, the processing means, or computer processor may be configured for processing basic instructions that drive the computer or system. As an example, the processing means or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing means, or computer processor may be a multicore processor. Specifically, the processing means, or computer processor may be or may comprise a Central Processing Unit (“CPU”). The processing means or computer processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processing means or processor may also refer to one or more processing devices, such as a distributed system of processing devices located across multiple computer systems (e.g., cloud computing), and is not limited to a single device unless otherwise specified.

The term “hardware logic circuitry” corresponds to one or more hardware processors (e.g., CPUs, GPUs, etc.) that execute machine-readable instructions stored in a memory, and/or one or more other hardware logic components (e.g., FPGAs) that perform operations using a task-specific collection of fixed and/or programmable logic gates. Section C provides additional information regarding one implementation of the hardware logic circuitry. Each of the terms “component” and “engine” refers to a part of the hardware logic circuitry that performs a particular function.

“Data storage medium” may refer to physical and other computer-readable media for carrying or storing computer-executable instructions and/or data structures. Such computer-readable media can be any available media that can be accessed by a general-purpose or special-purpose computer system. Computer-readable media may include physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

“Computer readable program instructions” described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

“Database” may refer to a collection of related information that can be searched and retrieved. The database can be a searchable electronic numerical, alphanumerical, or textual document; a searchable PDF document; a Microsoft Excel® spreadsheet; or a database commonly known in the state of the art. The database can be a set of electronic documents, photographs, images, diagrams, data, or drawings, residing in a computer readable storage media that can be searched and retrieved. A database can be a single database or a set of related databases or a group of unrelated databases. “Related database” means that there is at least one common information element in the related databases that can be used to relate such databases.

### SUMMARY

To address the above-mentioned problems in a perspective the following is proposed:

A computer-implemented method for assigning at least one human-perceived attribute to a sample coating based on a visual evaluation of the sample coating with respect to a reference coating, said method comprising at a computing device with a display:
(i) displaying on the display a user interface comprising at least one display image of a modified reference coating; and
(ii) detecting—with the computing device—a user input being indicative of selecting at least one display image of the modified reference coating; and
(iii) in response to the detected user input, assigning—with the computing device—at least one human-perceived attribute to the sample coating.

A computer-implemented method for assigning at least one human-perceived attribute indicating a deviation of a sample coating from a reference coating, wherein the sample coating has been prepared based on a reference coating and wherein the human-perceived attribute is assigned to the sample coating based on a visual evaluation of the sample coating with respect to the reference coating, said method comprising at a computing device with a display:
(i) displaying on the display a user interface comprising at least one display image of a modified reference coating, wherein the display image of the modified reference coating is generated by modifying appearance data associated with the reference coating and displaying the modified appearance data as display image(s) of the modified reference coating; and
(ii) detecting—with the computing device—a user input being indicative of selecting at least one displayed display image of the modified reference coating, wherein the user input is associated with the visual evaluation of the sample coating with respect to the reference coating; and
(iii) in response to the detected user input, assigning—with the computing device—at least one human-perceived attribute to the sample coating, wherein assigning includes mapping deviation(s) associated with the detected user input to predefined human-perceived attribute(s).

It is an essential advantage of the method according to the present invention that the possible visually perceived deviations between the sample coating prepared based on a provided reference coating and said reference coating are displayed using display images within a user interface. This allows the user to rate the deviations easily and intuitively in the virtual world represented by the user interface by selecting the display image of the modified reference coating that best describes the differences between the prepared sample coating and the reference coating visually perceived in the physical world. Hence, the difference between the sample coating and the reference coating in the physical world may be translated into the virtual world, e.g. into human-perceived attributes associated with the sample coating, using a standardized process. The human-perceived attributes may represent data that defines the visually perceived differences between the sample coating and the reference coating. The standardized process does not require deep knowledge of coloristics and reduces the risk of misinterpretation of wordings and terms commonly used to describe said color differences. This standardized process may be used during repair of damaged multilayer coatings to describe visually perceived differences between a prepared sample coating, such as a sample coating prepared from a sample coating material identified as matching during a color matching process, and the damaged reference coating. The human-perceived attributes derived from the visually perceived differences may be used to identify further sample coating materials being a better match in terms of appearance when compared to the reference coating. Labelling of the images of the modified reference coatings can be used to further improve the assessment process. The display images of the modified reference coating are obtained by manipulating the appearance data of the reference coating to a certain extent in possible directions and/or to extents of a predefined colorimetric space optionally using a color distance formula.

Further disclosed is:
An apparatus for assigning at least one human-perceived attribute to a sample coating, the apparatus comprising: a display; one or more computing nodes; and one or more computer-readable media having thereon computer-executable instructions that are structured such that, when executed by the one or more computing nodes, cause the apparatus to perform the inventive method described herein.

Further disclosed is:
Computer program element with instructions, which, when executed by a computing device, such as a computing device of a computing environment, is configured to carry out the steps of the inventive method or as provided by the inventive apparatus.

Any disclosure and embodiments described herein relate to methods, systems, apparatuses and computer elements disclosed herein and vice versa. Benefits provided by any of the embodiments and examples provided herein equally apply to all other embodiments and examples and vice versa.

### EMBODIMENTS

### Embodiments of the Inventive Method

According to the inventive computer-implemented method, at least one human-perceived attribute is assigned to a sample coating by a computing device. The sample coating can, for example, be prepared by identifying a matching sample coating formulation based on appearance data of the reference coating as commonly done during repair operations and preparing a coating by applying the matching sample coating formulation and optionally further coating formulations, such as clearcoat formulations, onto a substrate and curing the applied coating formulations. The computing device can be a mobile or stationary computing device, such as a personal computer, a laptop, a smartphones, a tablet, etc.

In an aspect, the human-perceived attribute indicates a deviation of the sample coating from the reference coating. The sample coating may be a sample coating prepared based on the reference coating, for example by using a color matching process identifying best matching sample coating materials. The reference coating may comprise one or more damaged areas. The reference coating may be a coating used as reference in terms of appearance. The deviation of the sample coating from the reference coating may be visually assessed, for example by visually comparing the sample coating and the reference coating. The deviation of the sample coating from the reference coating is preferably selected from a deviation in appearance. In one example, the deviation is a deviation in lightness and/or darkness. In another example, the deviation is a deviation in the color and/or texture. In yet another example, the deviation is a deviation in gloss. In an even further example, the deviation is a deviation in the clearcoat appearance. The latter may be preferred if the sample coating and the reference coating each comprise at least one clearcoat layer.

### Step (i):

In step (i) of the inventive method, at least one display image of a modified reference coating is displayed on the display within a user interface. The user interface may be generated from a user interface presentation and contains, apart from the display image(s) of the modified reference coating(s) further icons, menus, bars, text, labels or a combination thereof. The display may be part of the computing device or may be part of a separate display device connected via a communication interface to the computing device.

The display may be constructed according to any emissive or reflective display technology with a suitable resolution and color gamut. Suitable resolutions are, for example, resolutions of 72 dots per inch (dpi) or higher, such as 300 dpi, 600 dpi, 1200 dpi, 2400 dpi, or higher. This guarantees that the generated appearance data can displayed in a high quality. A suitably wide color gamut is that of standard Red Green Blue (sRGB) or greater. In various embodiments, the display may be chosen with a color gamut similar to the gamut perceptible by human sight. In an aspect, the display is constructed according to liquid crystal display (LCD) technology, in particular according to liquid crystal display (LCD) technology further comprising a touch screen panel. The LCD may be backlit by any suitable illumination source.

The color gamut of an LCD display, however, may be widened or otherwise improved by selecting a light emitting diode (LED) backlight or backlights. In another aspect, the display is constructed according to emissive polymeric or organic light emitting diode (OLED) technology. In yet another aspect, the display device is constructed according to a reflective display technology, such as electronic paper or ink. Known makers of electronic ink/paper displays include E INK and XEROX. Preferably, the display also has a suitably wide field of view that allows it to display images that do not wash out or change severely as the user views the display from different angles. Because LCD screens operate by polarizing light, some models exhibit a high degree of viewing angle dependence. Various LCD constructions, however, have comparatively wider fields of view and may be preferable for that reason. For example, LCD displays constructed according to thin film transistor (TFT) technology may have a suitably wide field of view. Also, displays constructed according to electronic paper/ink and OLED technologies may have fields of view wider than many LCD displays and may be selected for this reason.

In an aspect, the display image of the modified reference coating is modified with respect to the lightness and/or darkness and/or color and/or texture and/or gloss and/or clearcoat appearance as compared to a display image of the reference coating. The term “color” refers to the color, the chromaticity and the hue of the coating. For example, the display image of the modified reference coating has a darker color and/or a lighter color than the display image of the reference coating. In another example, the display image of the modified reference coating may be bluer, yellower, greener or redder than the display image of the reference coating. In yet another example, the display image of the modified reference coating may be more sparkling or less sparkling, coarser or finer than the display image of the reference coating. In yet a further example, the display image of the modified reference coating is glossier or less glossy, has more or less orange peel or a lower or higher DOI than the display image of the reference coating. Modification of the reference coating is preferably done to a predefined extend using a defined color space and optionally commonly known color tolerance equations or by adding a further layer to the reference coating appearance data, for example to modify the gloss or clearcoat appearance of the reference coating display image as described later on. Use of said display images allows to visualize possible deviations with respect to appearance between the sample coating and the reference coating and thus allows to easily determine the observed visual deviations without requiring a deep understanding about coloristics and the applicable terms to define deviations for the respective coating type, such as solid color coatings (i.e. a coating not containing effect pigments), effect color coatings (i.e. a coating containing effect pigments), chromatic coatings, achromatic coatings, etc.

In an aspect, step (i) further comprises displaying at least one display image of the reference coating within the user interface. This allows the user to better determine the observed deviation(s) because the user can compare the reference coating(s) and the modified reference coatings with respect to the appearance directly within the user interface. With preference, the at least one display image of the reference coating is displayed adjacent to at least part of the display images of the modified reference coating. With particular preference, a display image of the reference coating is displayed adjacent to each display image of the modified reference coatings. This allows to display deviations of the reference coating in two directions, for example more or less chromatic, by displaying the display image of the reference coating in between the display images of the modified reference coatings, for example the display image of the modified reference coating have a higher chromaticity and the display image of the modified reference coating having a lower chromaticity.

In an aspect, step (i) includes
(i-1) providing via a communication interface to the processor of the computing device a digital representation of the reference coating including appearance data determined at one or more measurement geometries;
(i-2) generating—with the processor—modified appearance display data of the reference coating based on the provided digital representation; and
(i-3) generating a user interface presentation that presents the modified appearance display data generated in step (i-2) as display image(s) of the modified reference coating and displaying the generated user interface presentation.

The term “appearance data” includes reflectance data, color data, such as color space data, texture characteristics, texture images, gloss data, shortwave values, longwave values, DOI values or a combination thereof. The term “texture characteristics” refers to the coarseness characteristics and/or sparkle characteristics of an effect coating. The coarseness characteristics and the sparkle characteristics of effect coatings can, for example, be determined from texture images acquired by multi-angle spectrophotometers as known in the state of the art. Texture images can be black-and-white images or can be color images. One example of color space data is defined by L*a*b*, where L* represents luminous intensity, a* represents a red/green appearance, b* represents a yellow/blue appearance. Another example of color space data is defined by L*, C*, h, where L* represents lightness, C* represents chroma, and h represents hue. Yet another example of color space data is defined by RGB, where R represents the red channel, G represents the green channel, and B represents the blue channel.

The term “appearance display data” refers to appearance data that is used to present the appearance of the reference coating as display image(s) while the term “modified appearance display data” refers to modified appearance data (e.g. appearance data that has been modified with respect to the appearance data of the reference coating) that is used to present the appearance of the modified reference coating as display image(s). Said appearance display data and modified appearance display data preferably has a standard dynamic range (SDR) format so that no additional tone mapping is required to display said data as it would be necessary for high dynamic range (HDR) data.

Apart from the appearance data, the digital representation of the reference coating provided in step (i-1) may further comprise the color name, the color code, a bar code, a QR code, a unique database ID, a mixing formula (i.e. instructions to prepare the coating materials used to prepare the reference coating), a color ranking, a price, the layer structure, the manufacturer of the coating materials used to prepare the reference coating, the manufacturer of the substrate comprising the reference coating, the model comprising the reference coating, the production year of the substrate comprising the reference coating, the car part comprising the reference coating, or a combination thereof.

Step (i-1):

In step (i-1), a digital representation of the reference coating is provided via a communication interface to the processor of the computing device. The digital representation of the reference coating includes appearance data determined at one or more measurement geometries. The digital representation of the reference coating can be provided in numerous ways, some of which are illustrated in a non-limiting manner in the following.

In one example, providing the digital representation of the reference coating includes
measuring the appearance of the reference coating at one or more measurement geometries with a measuring device and optionally determining appearance data from the measured data with the measuring device, and
retrieving—with the computer processor via the communication interface—the determined appearance data optionally in combination with measured data and/or further meta data and/or user input or
retrieving—with the computer processor via the communication interface—the measured data optionally in combination with further meta data and/or user input and determining appearance data from the measured data with the computer processor.

The appearance of the reference coating can be measured with suitable measuring devices, for example RGB cameras, single-angle spectrophotometers and multi-angle spectrophotometers. Commercially available RGB cameras include smartphone cameras, digital cameras, mirror cameras, etc. Commercially available multi-angle spectrometers are, for example, Byk-Mac® | or a spectrometer of the XRite MAR-T-family. Commercially available single-angle spectrophotometers include, for example,
the Byk ColorView, the Datacolor Spectraflash SF450 and the Konica Minolta CM 3600-d.

The measuring device is preferably connected to a computer processor via a communication interface. In one example, the processor is programmed to process the measured data, such as reflectance data and texture images, by calculating the appearance data for each measurement geometry from the measured reflectance and/or by calculating the texture characteristics for a defined measurement geometry from the acquired texture image. Said processor can be housed inside the computing device, i.e. the computing device retrieves the measured data and optionally further meta data and/or user input via the communication interface from the measuring device and calculates the appearance data using the retrieved data, or said processor is present separate from the computing device, for example within the measurement device. In this case, the computing device retrieves the determined appearance data, optionally in combination with further meta data and/or user input via the communication interface. In another example, the processor retrieves the measured data and optionally further data mentioned above without performing any further calculations, for example if an RGB camera was used to measure the appearance. In this case, the measured data corresponds to the appearance data.

The appearance data may be stored on a data storage medium, such as an internal memory or a database prior to providing the appearance data via the communication interface to the computing device or after providing said data to the computing device. This may include interrelating the appearance data with further data and/or meta data and/or user input prior to storing the appearance data such that the stored appearance data can be retrieved using the further data and/or meta data and/or user input if needed. Storing the appearance data may be preferred if said data is needed several times since the data does not have to be acquired each time the inventive method is performed.

Further data and/or meta data and/or user input may include a color number/color code/bar code/unique database ID associated with the respective coating, the layer structure of the respective coating, the wet or dry film thickness of the respective coating, instructions to prepare the respective coating material(s) associated with the respective coating, the price or a combination thereof.

In one example, the appearance data is obtained from data acquired at a single measurement geometry. This may be preferred if the reference coating is a solid color or straight shade coating or if a single-angle measurement device (i.e. a measurement device acquiring data of the appearance of the reference coating at only a single measurement geometry) is used. The term “solid color or straight shade coating” refers to coatings where the colored coating layers primarily contain colored pigments, and the coating does not exhibit a visible flop or two tone metallic effect, i.e. the visual appearance does not change with viewing and/or illumination angle.

In another example, the appearance data is obtained from data acquired at a plurality of measurement geometries, wherein the plurality of measurement geometries includes at least one gloss measurement geometry and at least one non-gloss measurement geometry. The term “gloss measurement geometry” refers to measurement geometries with an associated aspecular angle of up to 30°, for example of 10° to 30°, the aspecular angle being the difference between the observer direction and the gloss direction of the measurement geometry. Use of these aspecular angles allows to measure the gloss color produced by the effect pigments present in the effect coating. “Non-gloss measurement geometries” refers to measurement geometries with associated aspecular angles of more than 30°, i.e. to all measurement geometries not being gloss measurement geometries, such as, for example, flop measurement geometries and intermediate measurement geometries described hereinafter. Use of appearance data obtained from data acquired at a plurality of measurement geometries may be preferred if the reference coating is an effect coating, i.e. a coating comprising at least one colored coating layer containing effect pigment(s) and optionally other colored pigments or spheres which result in a visual flop or two-tone metallic effect, because the appearance of an effect coating changes with viewing and/or illumination angles.

In another example, the digital representation of the reference coating includes providing reference coating identification data, obtaining the digital representation of the reference coating based on provided reference coating identification data and providing the obtained digital representation. The digital representation of the reference coating can be obtained by retrieving the digital representation of the reference coating based on provided reference coating identification data and providing the retrieved digital representation via the communication interface to the computer processor. In one example, obtaining the digital representation of the reference coating based on the provided reference coating identification data includes accessing a database containing digital representations of reference coatings interrelated with reference coating identification data, such as appearance data of the reference coating, the color name, color code, bar code, etc. of the reference coating or further data being indicative of the reference coating, and retrieving the digital representation of the reference coating based on said provided data. Data being indicative of the reference coating may include the color name, color number, color code, bar code, ID, VIN in combination with car part information (e.g. bumper, trunk, etc.), etc. associated with the reference coating. The data being indicative of the reference coating may be inputted by the user via a GUI displayed on the display, retrieved from a database based on scanned code, such as a QR code, or may be associated with a pre-defined user action. Predefined user actions may include selecting a desired action on the GUI displayed on the display, such as, for example, displaying a list of stored measurements including associated images or displaying a list of available reference coatings according to searching criteria, user profile, etc.

The database is preferably connected to the computing device via a communication interface and the digital representation of the reference coating may be provided to the computing device by selecting a digital representation stored on a data storage medium, for example via a GUI displayed on the screen of the display or by entering data being indicative of the reference coating, such as the color name, the color code, etc. and retrieving the digital representation of the reference coating based on the entered data.

Step (i-2):

In step (i-2), modified appearance display data of the reference coating is generated with the processor of the computing device based on the digital representation provided in step (i-1).

The modified appearance data may be generated by modifying at least part of the appearance data contained in the provided digital representation of the reference coating with regard to lightness, darkness, color, texture, gloss, clearcoat appearance or a combination thereof.

In one example, modifying at least part of the appearance data includes using predefined color space distance values, in particular dL, da, db, dC, dH, and/or texture distance values. The appearance data of the modified reference coatings can be obtained by determining modified appearance data using the appearance data contained in the provided digital representation of the reference coating and the predefined color space distance values dL, da and db or dL, dC and dH in combination with well-known color tolerance equations, such as the in particular the Delta E (CIE 1994) color tolerance equation, the Delta E (CIE 2000) color tolerance equation, the Delta E (DIN 99) color tolerance equation, the Delta E (CIE 1976) color tolerance equation, the Delta E (CMC) color tolerance equation, the Delta E (Audi95) color tolerance equation, the Delta E (Audi2000) color tolerance equation or other color tolerance equations. Additional use a color tolerance equation, in particular the Audi95 or Audi2000 color tolerance equation, may be beneficial to achieve standardized offsets of the modified appearance data from the appearance data of the reference coating over the whole color space because the color space values are weighted according to the color and the measurement geometry.

Modification of the appearance data of the reference coating using predefined color space distance values allows to obtain modified appearance display data appearing greener or redder or bluer or yellower or darker or brighter or less chromatic or more chromatic or having a positive hue shift or having a negative hue shift if displayed within the user interface on the display.

Modification of the appearance data of the reference coating layer using predefined texture distance values allows to obtain modified appearance display data appearing less sparkling or more sparkling or finer or coarser if displayed within the user interface on the display.

In another example, modifying the appearance data includes adding a predefined appearance layer to at least part of the appearance data. Modification of the of the appearance data of the reference coating layer by adding a predefined appearance layer, in particular a predefined clearcoat appearance layer, allows to obtain modified appearance display data appearing glossier or less glossy or having a higher or lower orange peel within the user interface on the display.

In an aspect, step (i-2) further includes:
generating a color image by calculating corresponding color data, in particular CIEL*a*b* values, for each pixel in the created image based on
   an ordered list of measurement geometries generated from the digital representation provided in step (i-1) and
   the generated modified appearance data, or—if at least one L*value included in the generated modified appearance data is greater than 90-scaled modified appearance data and
optionally adding a texture layer pixel-wise to each generated color image using a lightness scaling factor s_{L} an aspecular-dependent scaling function sf_{aspecular} and optionally a texture contrast scaling factor s_{c}.

The generated color images and thus also the appearance display data corresponding to said color images or generated by adding a texture layer to said color images preferably has a defined resolution. Suitable resolutions range from 160×120 pixels to 720×540 pixels, in particular 480×360 pixels. The defined resolution of the color images can be achieved, for example, by creating empty image(s) by defining the number of pixels in the x- and y-direction and using the created empty image(s) to generate the color image(s).

The ordered list of measurement geometries may be generated from the provided digital representation by
selecting at least one pre-defined measurement geometry from the one or more measurement geometries contained in the digital representation and optionally sorting the selected measurement geometries according to at least one pre-defined sorting criterium if more than one measurement geometry is selected, and
optionally calculating the accumulated delta aspecular angle for each selected measurement geometry if more than one measurement geometry is selected.

In one example, the at least one predefined measurement geometry includes at least one gloss measurement geometry and at least one non-gloss measurement geometry or at least one, in particular exactly one, intermediate measurement geometry. The at least one intermediate measurement geometry preferably corresponds to an aspecular angle of 45°. In the first case, at least two pre-defined measurement geometries are selected from the plurality of measurement geometries contained in each provided digital representation, namely at least one gloss and at least one non-gloss measurement geometry. In this case, the selected measurement geometries are sorted according to at least one pre-defined sorting criterium. In the latter preferred case, exactly one pre-defined measurement geometry, namely an intermediate measurement geometry, is selected from the one or more measurement geometries contained in each provided digital representation. In this case, a sorting of the pre-defined measurement geometry is not necessary.

The at least one pre-defined sorting criterium may include a defined order of measurement geometries. This defined order of measurement geometries is preferably selected such that a visual 3D impression, for example a visual impression of a bend metal sheet, is obtained if the appearance display data is displayed within the user interface. Examples of defined orders of measurement geometries include 45°>25°>15°>25°>45°>75 and −15°>15°>25°>45°>75°>110°. Use of these defined orders of measurement geometries may be beneficial for effect coatings because this order results in color images displaying the color travel of the effect coating under directional illumination conditions. The at least one pre-defined measurement geometry and/or the at least one pre-defined sorting criterium may be retrieved by the computer processor from a data storage medium based on the provided digital representation of the reference coating and/or further data. Further data may include data on the user profile or data being indicative of the measurement device and the measurement geometries associated with the measurement device.

The delta aspecular angle for each measurement geometry is the absolute difference angle between the aspecular angle associated with a selected measurement geometry, for example the aspecular angle of 45°, and the aspecular angle associated with the following selected measurement geometry, in this example an aspecular angle of 25°. The accumulated delta aspecular angle can be obtained by adding the delta aspecular angle associated with a selected measurement geometry, for example the delta aspecular angle associated with 25°, to the delta aspecular angle associated with the following selected measurement geometry, in this case the delta aspecular angle associated with 15° and repeating this step for each measurement geometry in the ordered list.

If at least one L* value contained in the generated modified appearance data is greater than 90, preferably greater than 95 or 99, all L* values included in the generated modified appearance data are scaled using at least one lightness scaling factor s to generate a scaled digital representation. Use of this scaling factor allows to retain the color information contained in the gloss measurement geometries by compressing the color space while the existing color distances are kept constant. If no color space compression would be performed, L* values of more than 90, preferably of more than 95, in particular of more than 99, would be displayed with a cropped hue as almost or purely white, i.e. devoid of equidistancy of color information which may be present in the a* and b* values associated with these L* values. The lightness scaling factor si may be based on the maximum measured L* value of the CIEL*a*b* values included in the provided digital representation.

In one example, calculating corresponding color data, in particular CIEL*a*b* values, for each pixel in each created image includes correlating one axis of each created image with the generated ordered list of measurement geometries and mapping the ordered list of measurement geometries and associated digital representation or scaled digital representation, in particular the associated color values or scaled color values, to the correlated row in the created image. An interpolation method, in particular a spline interpolation method, may be used to calculate the intermediate CIEL*a*b* values, i.e. the CIEL*a*b* values for pixels which are not associated with measured geometries, to obtain smooth transitions between CIEL*a*b* values for pixels associated with a measured geometry and intermediate CIEL*a*b* values. The calculated CIEL*a*b* values may be converted into sRGB values and optionally stored on a data storage medium, in particular the internal memory of the computing device. Conversion of the calculated CIEL*a*b* values to sRGB values allows to display the calculated color information with commonly available displays which use sRGB files to display information.

A texture layer may be added to the generated color image(s) to provide spatially resolved texture information (e.g. distribution, size distribution, lightness distribution) or information on the texture color. This may be preferred if the reference coating is an effect coating containing a visible texture. The lightness scaling factor si used during addition of the texture layer preferably corresponds to the lightness scaling factor si used during generation of the color image(s), i.e. the same lightness scaling factor s_{L} is preferably used, or is set to 1 in case no lightness scaling factor s_{L} is used during the generation of the color image(s). Use of the same lightness scaling factor s_{L} allows to adjust the lightness of the texture image to the lightness of the color image, thus preventing a mismatch of the color and texture information with respect to lightness. The aspecular-dependent scaling function sf_{aspecular} used during addition of the texture layer weights each pixel of the texture layer in correlation with the aspecular angles corresponding to the measurement geometries present in generated ordered list of measurement geometries. This allows to weight the pixels of the texture layer in correlation with the visual impression of the effect coating layer under different measurement geometries and therefore results in generated appearance data closely resembling the visual impression of the effect coating layer when viewed from different viewing angles by an observer. In general, the visual texture, i.e. the coarseness characteristics and the sparkle characteristics, is more prominent in the gloss measurement geometries than in the flop geometries. To take this into account, the aspecular-dependent scaling function sf_{aspecular} preferably outputs scaling factors s_{aspec} close to 1 for gloss measurement geometries and scaling factors s_{aspec} close to 0 for flop measurement geometries.

The texture layer may be added pixel-wise by
providing at least one acquired or synthetic texture image,
generating modified texture image(s) by computing the average color of each provided acquired or synthetic texture image and subtracting the average color from the respective provided acquired or synthetic texture image, and
adding the respective modified texture image pixel-wise weighted with the lightness scaling factor s_{L}. the aspecular dependent scaling function sf_{aspecular} and optionally the contrast scaling factor s_{c} to the respective generated color image.

“Acquired texture image” refers to texture images, such as grey scale or color images, which have been acquired using a multi-angle spectrophotometer as previously described. In contrast, the term “synthetic texture image” refers to a texture image which has been generated from texture characteristics, such as the coarseness and/or sparkle characteristics, determined from the acquired texture images as previously described.

The synthetic texture image can be created by
creating an empty image,
providing a target texture contrast cᵥ,
generating a random number by a uniform or a gaussian random number generator between −cᵥ and +cᵥ for each pixel in the created image and adding the generated random number to each pixel in the created image,
blurring the resulting image using a blur filter, in particular a gaussian blur filter, and
optionally providing the resulting synthetic texture image.

The created empty image preferably has the same resolution as the color image to prevent a mismatch of the texture layer upon addition of the texture layer to the generated color image. This also renders downscaling of the texture layer prior to addition of the said layer to the color image(s) superfluous. The target texture contrast cᵥ preferably corresponds to the sparkle and/or coarseness characteristics or to a predefined value associated with the formulation of the reference coating material. The predefined value may be retrieved from a database based on the formulation of the reference coating material, for example based on the type and/or amount of effect pigments being present in the formulation of the reference coating material.

An identical resolution is used for all color image(s) calculated in step (i-2). Use of a different resolution of the display images may be preferred if the display images of the reference coating are to be displayed in different sizes while the same resolution is preferably used if all display images of the reference coating are to be displayed in the same size.

Moreover, it is preferred that an identical generated ordered list of measurement geometries is used during generation of all color images in step (i-2). This allows to visually compare the modified appearance display data because each line in the displayed data (e.g. the display images of modified reference coatings) belongs to the same measurement geometry (e.g. the same aspecular angle) if the generated appearance data is displayed side by side in a horizontal arrangement.

The same scaling factor s_{L} is preferably used to scale all L* values of the modified appearance data. This guarantees that any visual differences between the generated modified appearance display data, in particular in the regions associated with gloss measurement geometries, is not due to the use of different lightness scaling factors s_{L} and thus results in display images optimized for visual comparison of different coatings.

The modified appearance data of the reference coating may be generated based on the provided digital representation and a user input being indicative of selecting at least one category being indicative of a visual deviation of the sample coating from the reference coating, wherein the user input is detected by displaying a user interface comprising the at least one category

The at least one visual deviation of the sample coating from the reference coating may include a deviation in lightness, a deviation in darkness, a deviation in color, a deviation in texture, a deviation in gloss and a deviation in clearcoat appearance. The category may be denoted with a text label indicating the type of the deviation, such as color deviation, texture deviation, gloss deviation, etc.

Selection of a category may simplify identification of the display image of the modified reference coating matching the sample coating because the number of display images of modified reference coatings displayed within the user interface is significantly reduced by displaying display images of modified reference coatings obtained by modifying the appearance of the reference coating only with respect to the selected category.

Step (i-3):

In step (i-3) a user interface presentation that presents the modified appearance display data generated in step (i-2) as display image(s) of the modified reference coating is generated and the generated user interface presentation is displayed on the display. Displaying the generated appearance display data of the reference coating in step (i-3) may simplify selection of the display image of the modified reference coating which most closely matches the deviation of the sample coating from the reference coating visually perceived in the physical world because possible deviations between reference coating and sample coating are mimicked in the virtual world via the user interface by using display images of modified reference coatings.

Step (i) may comprise a further step (i-4) of generating—with the processor—appearance data of the reference coating based on the provided digital representation and presenting the generated appearance data as display image of the reference coating. The display image may be displayed within the user interface presentation generated in step (i-3). Step (i-4) may be performed prior to step (i-3). Step (i-4) may be performed prior to step (i-2). Step (i-4) may be performed after step (i-3). Step (i-4) may be performed, for example, if at least one display image of the reference coating generated from CIEL*a*b* values of the reference coating is to be displayed within the user interface in step (i). In case an RGB image of the reference coating has been provided in step (i-1), step (i-4) may be omitted because the provided RGB image can directly be used as display image of the reference coating. Displaying at least one display image of the reference coating may be beneficial to mimic the visual comparison of the reference coating with the sample coating performed in the physical world within the virtual world represented by the user interface such that selection of the display image of the modified reference which most closely resembles the appearance of the sample coating or which most closely resembles the visually perceived difference between the sample coating and the reference coating is facilitated for the user.

Step (i-4) may include:
generating a color image by calculating corresponding color data, in particular CIEL*a*b* values, for each pixel in the created image based on
   an ordered list of measurement geometries generated from the digital representation provided in step (i-1) and
   the digital representation provided in step (i-1) or—if at least one L*value included in the provided digital representation is greater than 90—a scaled digital representation, and
optionally adding a texture layer pixel-wise to each generated color image using a lightness scaling factor s an aspecular-dependent scaling function sf_{aspecular} and optionally a texture contrast scaling factor s_{c}.

Generation of the ordered list of measurement geometries, the scaled modified appearance data and the color image(s) as well as addition of the texture layer can be performed as previously described in relation to step (i-2).

An identical resolution may be used for all color image(s) calculated in step (i-4). If step (i-2) is performed, the same resolution or a different resolution for the color images generated in steps (i-2) and (i-4) may be used. Use of a different resolution of the display images of the reference coating and the display images of the modified reference coating may be preferred if the display images of the reference coating are to be displayed in a larger or smaller size than the display images of the modified reference coating while the same resolution is preferably used if the display images of the reference coating and the modified reference coating(s) are to be displayed in the same size.

An identical generated ordered list of measurement geometries may be used during generation of all color images in step (i-4). If step (i-2) is performed, the list of ordered measurement geometries used in step (i-2) may also be used in step (i-4). This allows to visually compare the appearance display data of the reference coating with the modified appearance display data because each line in the displayed data (e.g. the display images of modified reference and optionally reference coatings) belongs to the same measurement geometry (e.g. the same aspecular angle) if the generated appearance data is displayed side by side in a horizontal arrangement.

The same scaling factor si may be used to scale all L* values of the modified appearance data. If step (i-2) is performed, the scaling factor s used in step (i-2) may also be used for generating the modified appearance display data in step (i-4). This guarantees that any visual differences between the generated modified appearance display data and the appearance display data, in particular in the regions associated with gloss measurement geometries, is not due to the use of different lightness scaling factors s_{L} and thus results in display images optimized for visual comparison of different coatings.

In an aspect, step (i) further includes displaying a label for at least part of the display images of the modified reference coatings, said label being indicative of the modification of the reference coating with regard to lightness or darkness or color or texture or gloss or clearcoat appearance. The label may simplify selection of the display image of the modified reference coating most closely matching the appearance of the sample coating with respect to the reference coating because it indicates the direction of deviation the user is observing.

### Step (ii):

In step (ii) of the inventive method, a user input being indicative of selecting at least one display image of the modified reference coating is detected with the computing device. The user input may be based on visually perceived differences between the prepared sample coating and the provided reference coating. The user input may be associated with visually perceived differences between the prepared sample coating and the provided reference coating. For instance, the user may visually compare the sample coating with the reference coating and may select the display image of the modified reference coating most closely resembling the appearance of the sample coating or most closely resembling the observed visual difference between the prepared sample coating and the provided reference coating. The visual comparison of the sample coating with the provided reference coating may be performed prior to selecting the at least one display image. Selecting the at least one display image may include performing a user input on the respective display image. Hence selecting may be understood in terms of performing a user input on a respective display image.

The user input is preferably provided by an input device. “Input device” may refer to any device that provides an input signal in response to a user input, i.e. that allows a user to perform an input and, in response to that user input, provides an input signal to the computer system being indicative of the user input. Suitable input devices include a mouse device, touch-sensitive surface, a keyboard, etc. In one example, the touchscreen is present within the display such that the display also functions as input device. The user input is detected by a processor present within the display and provided to the processor of the computing device via a communication interface. In another example, the input device is present separate from the display. In this case, the input device is connected to computing device via a communication interface to allow detection of the user input by the processor of said computing device.

Step (iii):

In step (iii), at least one human-perceived attribute is assigned by the computing device to the sample coating in response to the detected user input. The human-perceived attribute may correspond to a difference visually perceived by a human observer, such as a refinisher in a body shop repairing the damaged reference coating, upon visually comparing the provided reference coating and the prepared sample coating. For this purpose, the computer processor determines the which display image(s) of the modified reference coating was/were selected in step (ii) and assigns at least one human-perceived attribute to the sample coating based on said determination.

In an aspect, assigning at least one human-perceived attribute to the sample coating in response to the detected user input includes mapping deviation(s) associated with the detected user input to respective human-perceived attribute(s). Respective human-perceived attributes may include predefined human-perceived attributes. Thus, deviation(s) associated with the display image of the modified reference coating selected by the user are mapped to the respective human-perceived attribute(s) to allow assigning of the human-perceived attributes to the sample coating. The deviation(s) associated with the display image of the modified reference coating are determined by determining the display image of the modified reference coating selected in step (ii) and identifying the associated deviation(s). The mapping may be performed using a mapping table in which each deviation, such as, for example, dL+2, is assigned to a respective human-perceived attribute, for example lighter.

### Further Steps:

In an aspect, steps (i) to (iii) or (ii) and (iii) are repeated at least once. This may be preferred if the user wants to select at least two display images of modified reference coatings. This may, for example, be the case if the sample coating deviates in the color and the texture from the reference coating and the user wants to select both deviations by clicking on the display images of the modified reference coatings best reflecting the observed deviations of the sample coating from the reference coating.

### Step (iv):

In an aspect, the inventive method includes a step (iv) of storing the human-perceived attributes assigned to the sample coating and the digital representation of the reference coating on a data storage medium. This may include interrelating the data with a unique ID and optionally data being indicative of the sample coating such that said ID or data can be used to retrieve the human-perceived attributes from the data storage medium. The data storage medium is preferably a database connected to the computing device via a communication interface.

### Step (v):

In an aspect, the inventive method further includes a step (v) of determining at least one further sample coating based on the assigned human-perceived attributes. For this purpose, at least one adjusted sample coating is calculated, and it is then determined whether the calculated adjusted sample coating improves at least one assigned human-perceived attribute. The at least one adjusted sample coating can be calculated using color adjustment processes well-known in the state of the art, such as, for example, described in EP 2149038 B1.

Determining of whether the adjusted sample coating improves at least one assigned human-perceived attributes can, for example, be performed by
calculating the color data of the adjusted sample coating, determining—for each determined human-perceived attribute—the difference between the adjusted sample coating and the reference as well as the difference between the sample coating and the reference coating based on the provided digital representations of the adjusted sample coating, the sample coating and the reference coating, and
determining—for each determined human-perceived attribute—if the difference between the adjusted sample coating and the reference coating is less than the difference between the sample coating and the reference coating.

If the adjusted sample-coating does not improve at least one, in particular all, human-perceived attributes, a list of matching sample coatings retrieved by performing a database search may be displayed to the user. If the adjusted sample coating does improve at least one, in particular all, human-perceived attributes, the formulation of the adjusted sample coating is displayed to the user.

Using the human-perceived attributes assigned to the sample coating to determine whether an adjusted sample coating improves said attributes allows to provide adjusted sample coatings more accurately matching the visual appearance of the reference coating.

### Embodiments of the Inventive Apparatus:

In an aspect, the inventive apparatus further comprises, apart from the display, the one or more computing nodes and the one or more computer-readable media, at least one appearance measurement device. The term “appearance measurement device” refers to any measurement device which is suitable to acquire data on the appearance, such as the color, the texture, the gloss and/or the clearcoat appearance, of a coating. Such suitable measurement devices include cameras, for example smartphone cameras or other color cameras, single-angle or multi-angle spectrophotometers, gloss meters and measurement devices for determining orange peel (i.e. shortwave and longwave values) and DOI.

In an aspect, the inventive apparatus further comprises at least one database containing the digital representations of the reference coating. The database is preferably connected via a communication interface with the one or more computing nodes to allow retrieval of respective digital representations from the database by the one or more computing nodes.

### BRIEF DESCRIPTION OF THE DRAWINGS

These and other features of the present invention are more fully set forth in the following description of exemplary embodiments of the invention. To easily identify the discussion of any particular element or act, the most significant digit or digits in a reference number refer to the figure number in which that element is first introduced. The description is presented with reference to the accompanying drawings in which:

FIG. 1 illustrates a flow diagram of a first embodiment of the inventive computer-implemented method for assigning at least one human-perceived attribute to a sample coating.

FIG. 2 illustrates a flow diagram of an embodiment of displaying a user interface described in block 102 of FIG. 1 in accordance with implementations of the invention.

FIG. 3 illustrates a flow diagram of an embodiment of generating appearance data of the reference coating described in block 208 of FIG. 2 in accordance with implementations of the invention.

FIGS. 4A-4C illustrate flow diagrams of an embodiment of generating modified appearance data of the reference coating described in block 212 or 218 of FIG. 2 in accordance with implementations of the invention.

FIG. 5 illustrates a flow diagram of a second embodiment of the inventive method for assigning at least one human-perceived attribute to a sample coating.

FIG. 6 illustrates a block diagram of an apparatus for assigning at least one human-perceived attribute to a sample coating in accordance with implementations of the invention.

FIG. 7 is a planar view of a display device comprising a screen populated with a graphical user interface displaying display images of a reference coating and display images of modified reference coatings.

FIG. 8 is a further planar view of a display device comprising a screen populated with a graphical user interface displaying display images of a reference coating and display images of modified reference coatings.

### DETAILED DESCRIPTION

The detailed description set forth below is intended as a description of various aspects of the subject-matter and is not intended to represent the only configurations in which the subject-matter may be practiced. The appended drawings are incorporated herein and constitute a part of the detailed description. The detailed description includes specific details for the purpose of providing a thorough understanding of the subject-matter. However, it will be apparent to those skilled in the art that the subject-matter may be practiced without these specific details.

In one case, the illustrated separation of various parts in the figures into distinct units may reflect the use of corresponding distinct physical and tangible parts in an actual implementation. Alternatively, or in addition, any single part illustrated in the figures may be implemented by plural actual physical parts. Alternatively, or in addition, the depiction of any two or more separate parts in the figures may reflect different functions performed by a single actual physical part.

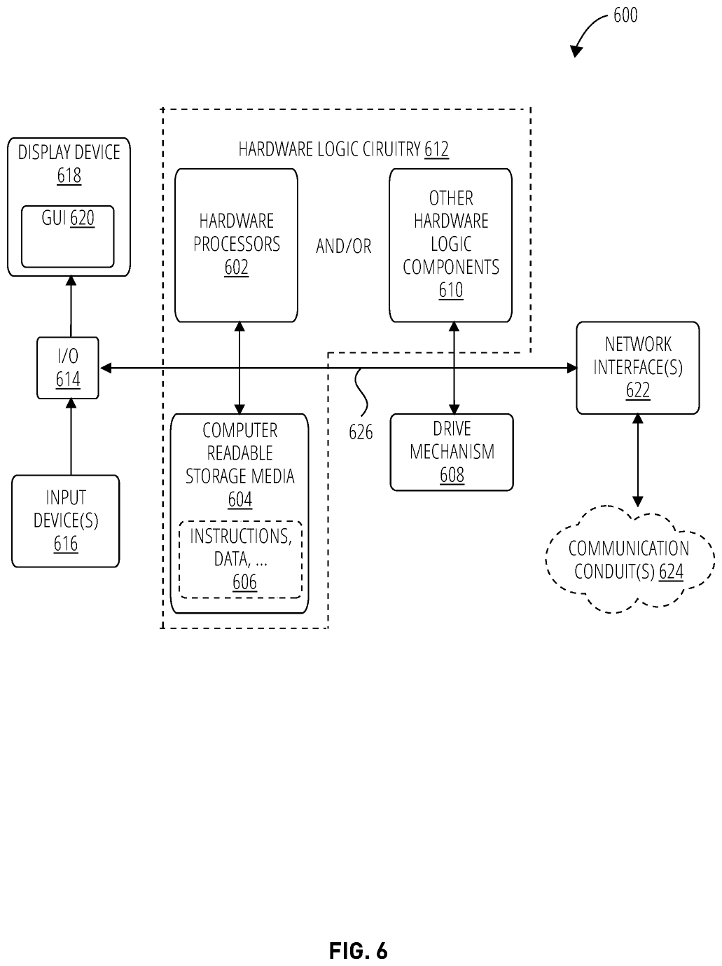

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by the hardware logic circuitry described in relation to FIG. 6, which, in turn, can be implemented by one or more hardware processors and/or other logic components that include a task-specific collection of logic gates.

As to terminology, the phrase “configured to” encompasses various physical and tangible mechanisms for performing an identified operation. The mechanisms can be configured to perform an operation using the hardware logic circuitry described in relation to FIG. 6. The term “logic” likewise encompasses various physical and tangible mechanisms for performing a task. For instance, each processing-related operation illustrated in the flowcharts corresponds to a logic component for performing that operation. A logic component can perform its operation using the hardware logic circuitry as described in relation to FIG. 6. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

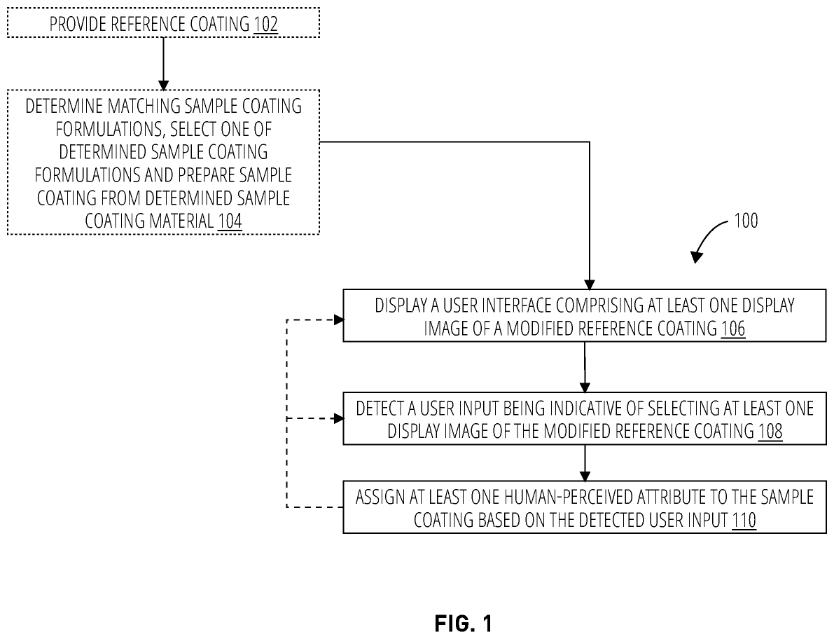

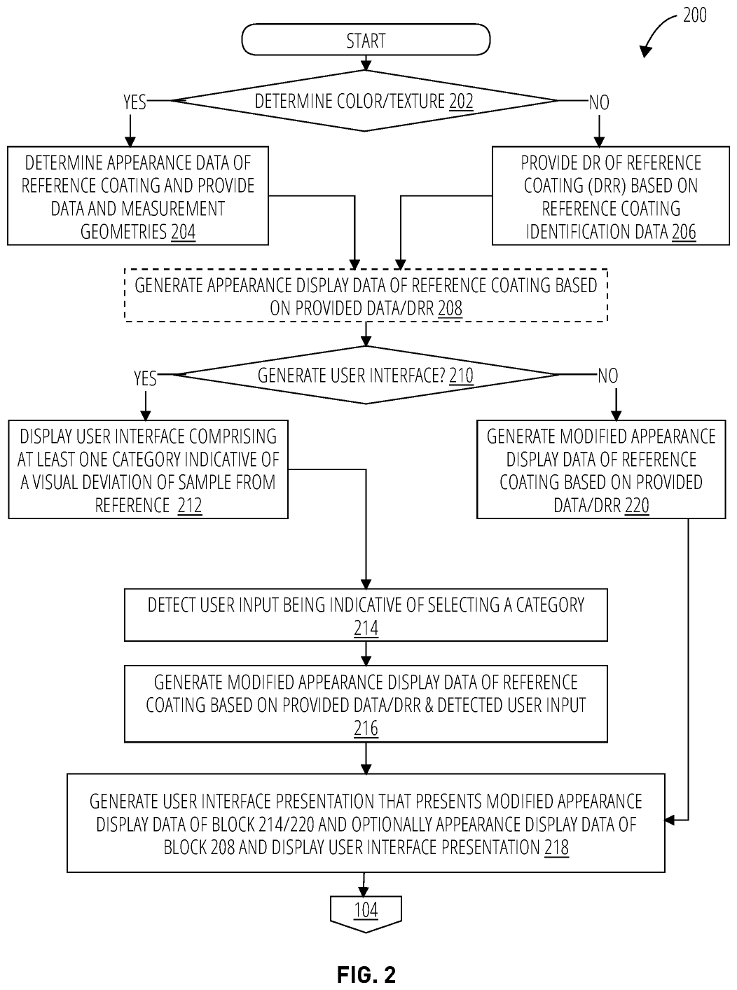

FIG. 1 depicts a first non-limiting embodiment of a computer-implemented method 100 for assigning at least one human-perceived or visually perceived attribute to a sample coating, said method being implemented by a computing device comprising a computer processor and a display, such as the computing device described in the context of FIG. 6. The computing device may comprise the display and may be a mobile device having an LCD display, such as a tablet or laptop. The computing device may be a stationary device, such as a stationary computer being attached to a peripheral display, such as an LCD screen. The reference coating and the sample coating may be effect coatings comprising effect pigment(s). The reference coating and the effect coating may be solid shade coatings comprising color pigments but being free of effect pigments. The sample coating may be prepared by providing a reference coating (block 102) and determining the appearance of the reference coating. The reference coating may correspond to a multilayer coating comprising one or more damaged areas within the multilayer coating. The appearance of the reference coating may be determined as described in the context of FIG. 2. The determined appearance may be used to determine best matching sample coating formulations using commonly known color matching processes. One of the identified best matching sample coating formulations may be selected and may be used to prepare a sample coating using said selected sample coating formulation and optionally a further clearcoat formulation (see block 104). The sample coating may be prepared by applying a sample coating material prepared from the selected sample coating formulation and optionally a clearcoat coating material to the surface of a substrate and curing the applied coating materials, either jointly or separately. After preparing the sample coating, a user may initiate method 100.

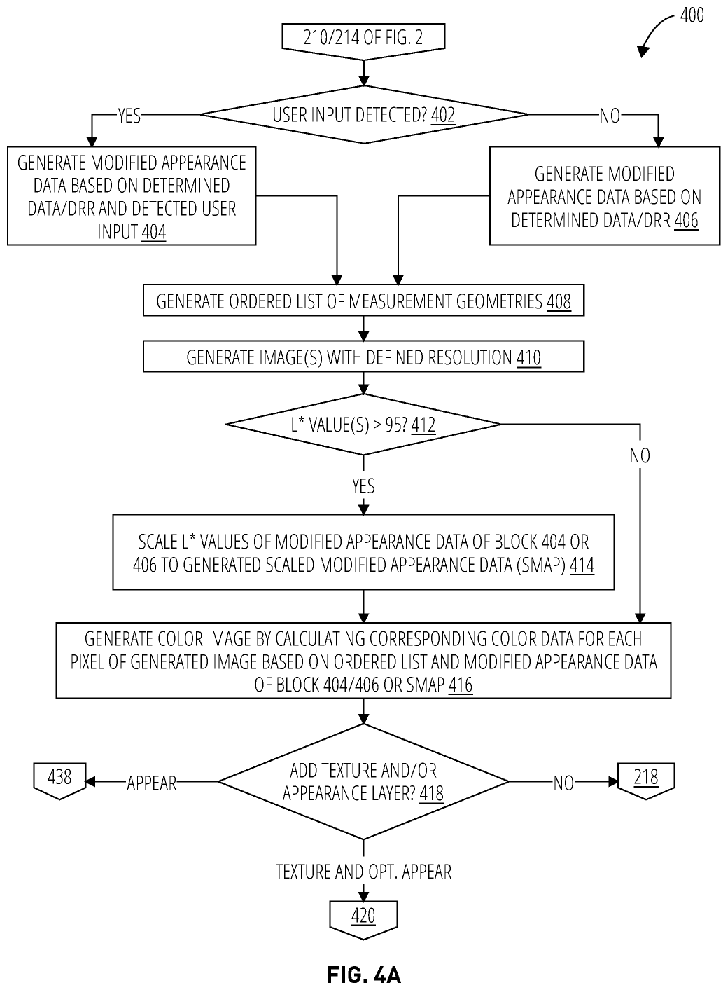

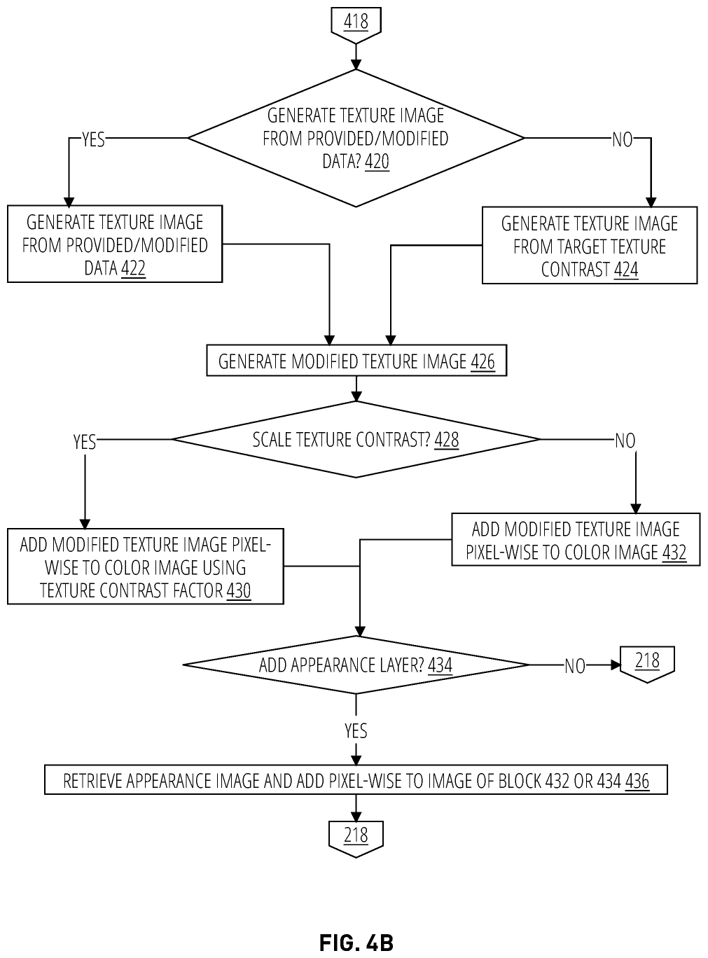

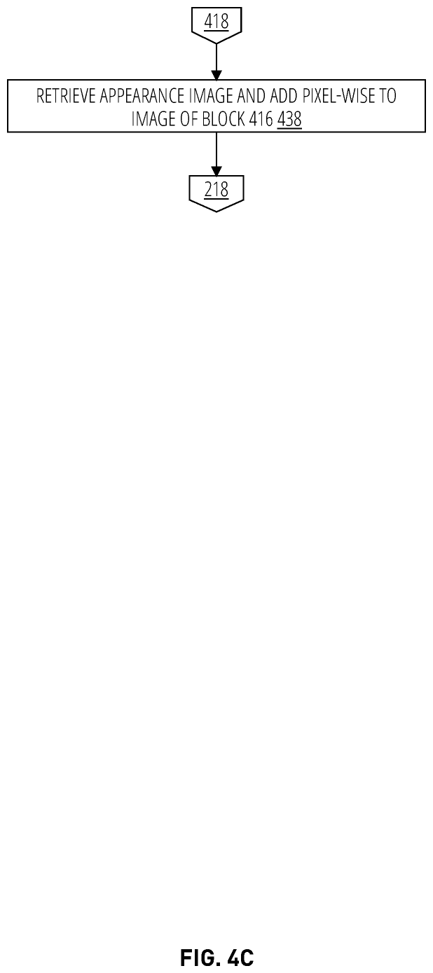

In block 106, a user interface may be displayed on the display, said user interface comprising at least one display image of a modified reference coating. The user interface may be generated as described in the context of FIG. 2. The display image of the modified reference coating may be generated as described in the context of FIGS. 4A to 4C. The user interface may further comprise at least one display image of the reference coating. This allows the mimic the visual comparison between reference coating and the prepared sample coating in the physical world within the virtual world represented by the user interface, thus facilitating selection of the display image of the modified reference coating most closely resembling the appearance of the prepared sample coating. The at least one display image of the reference coating may be displayed adjacent to at least part of the display images of the modified reference coating. This allows to display deviations from the reference coating in two directions, for example more or less chromatic, by displaying the display image of the reference coating in between the display images of the modified reference coating, for example the display image of the modified reference coating have a higher hue and the display image of the modified reference coating having a lower hue.

In block 108, a user input being indicative of selecting at least one display image of the modified reference coating may be detected with the computing device. For this purpose, the computing device may be coupled via the communication interface with an input device to allow detection of the user input. Suitable input devices may include a mouse device, touch-sensitive surface, a keyboard, etc. The display may comprise a touchscreen and may function as input device by detecting a touchscreen gesture as user input. The input device may be connected to the computing system via a communication interface to allow detection of the user input by the processor of said computing device. The user input may be based on visually perceived differences between the prepared sample coating and the provided reference coating. The user input may be associated with visually perceived differences between the prepared sample coating and the provided reference coating. For instance, the user may visually compare the prepared sample coating with the reference coating and may select the display image of the modified reference coating most closely resembling the appearance of the sample coating or most closely resembling the observed visual difference between the prepared sample coating and the provided reference coating. The visual comparison of the prepared sample coating with the provided reference coating may be performed by the user prior to block 106. The visual comparison of the prepared sample coating with the provided reference coating may be performed by the user after block 106. The visual comparison of the prepared sample coating with the provided reference coating may be performed by the user during to block 108, for example prior to performing the user input.

In block 110, at least one human-perceived attribute may be assigned by the computing device to the sample coating in response to the detected user input. The human-perceived attribute may correspond to a difference visually perceived by a human observer, such as a refinisher in a body shop repairing the damaged reference coating, upon visually comparing the provided reference coating and the prepared sample coating. For this purpose, the display image(s) of the modified reference coating selected in block 108 may be determined. Afterwards, at least one human-perceived attribute may be assigned to the sample coating by mapping deviation(s) associated with the determined display images to respective or predefined human-perceived attribute(s). For this purpose, the deviations associated with the display image of the modified reference coating selected in block 108 may be determined and may be mapped to the respective or predefined human-perceived attribute(s) to allow assigning of the human-perceived attributes to the sample coating. The mapping may be performed using a mapping table in which each deviation used to generate modified appearance data of the reference coating, such as, for example, dL+2, is assigned to a respective human-perceived attribute, for example lighter.

Blocks 106 to 110 or blocks 108 and 110 may be repeated, for example if a further deviation of the sample coating from the reference coating is to be selected based on the displayed images. Blocks 106 to 110 may be repeated in case a category is selected in block 106 to allow selection of another category while blocks 108 and 110 may be repeated if deviations of different categories, such as color, texture, gloss, clearcoat appearance, of the sample coating from the reference coating are displayed in block 106.

After the end of block 110, method 100 may end or may return to block 106.

FIG. 2 shows an illustrative method 200 for generating a user interface presentation used within the computer-implemented method for assigning at least one human-perceived or visually perceived attribute to a sample coating, such as the user interface displayed in block 106 of FIG. 1, on a display of a computing device. The user interface presentation may present modified appearance display data (e.g. display images of the modified reference coating) and optionally appearance display data (e.g. display image(s) of the reference coating). The user interface presentation may contain further content, like icons, text, labels, menus, etc.

In block 202, the routine implementing method 200 may determine whether the user wants to determine the color and/or texture of the reference coating or whether the digital representation of the reference coating is to be retrieved from a database (see block 206). The color and/or texture of the reference coating may, for example, be determined by measuring the color and/or texture as previously described. A graphical user interface (GUI) may be displayed where the user can make the appropriate selection and depending on the user selection the routine implementing method 200 may proceed to block 204 or 206. The routine implementing method 200 may detect acquisition of measurement data or the provision of appearance data and may automatically proceed to block 204. If it is determined in block 202 that the color and/or the texture is to be determined, the routine implementing method 200 may proceed to block 204. In case no color and/or texture of the reference coating is to be determined—for example if the appearance data is to be retrieved from a database—the routine implementing method 200 may proceed to block 206 described later on.

In block 204, the color and/or texture of the reference coating may be determined using a measurement device, such as an RGB camera, a single-angle spectrophotometer or a multi-angle spectrophotometer as previously described. The measurement device may be connected to the computing device via a communication interface to allow data transfer. If a spectrophotometer is used, appearance data may either be determined by the processor of the spectrophotometer from the acquired reflectance data and texture images or the appearance data may be determined by the computing device using the acquired reflectance data and texture images. If a single-angle or multi-angle spectrophotometer may be used, the appearance data may be determined by the spectrophotometer and may be provided to the computing device via the communication interface. Along with the appearance data, at least the used measurement geometries and optionally further meta data and/or user input may be provided to the computing device. If an RGB camera is used, appearance data in the form of RGB values of each pixel may be directly acquired by the camera and may be transferred as appearance data to the computing device without requiring any further calculations. The color and texture may be determined using a multi-angle spectrophotometer to acquire reflectance data at viewing angles of −15°, 15°, 25°, 45°, 75° and 110° using an incident angle of 45° and texture images.

In block 206, the digital representation of the reference coating (denoted as DRR hereinafter) may be provided. Providing the DRR may include retrieved the DRR from a database based on reference coating identification data. Reference coating identification data may include the color name, color number, color code, bar code, ID, VIN in combination with car part information (e.g. bumper, trunk, etc.), etc. associated with the reference coating. The data being indicative of the reference coating may be inputted by the user via a GUI displayed on the display, retrieved from a database based on scanned code, such as a QR code, or may be associated with a pre-defined user action. Predefined user actions may include selecting a desired action on the GUI displayed on the display, such as, for example, displaying a list of stored measurements including associated images or displaying a list of available reference coatings according to searching criteria, user profile, etc.

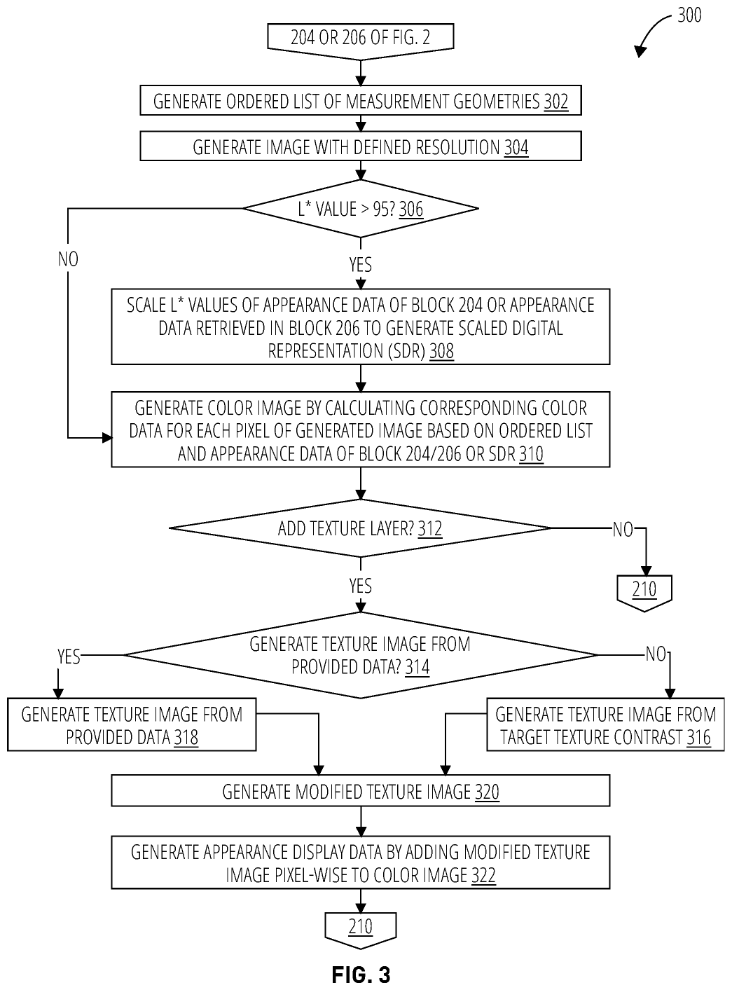

In block 208, appearance display data of the reference coating may be generated based on the appearance data provided in block 204 or the digital representation retrieved in block 206, this block generally being optional. Appearance display data of the reference coating may be generated as described in relation to FIG. 3 below. In general, this block should be performed if the appearance data is not RGB data, such as CIEL*a*b* values, and the display images of the reference coating are to be displayed in block 216. For instance, block 208 may be performed if appearance data in the form of CIEL*a*b* values and texture characteristics has been provided to allow presentation of display image(s) of the reference coating within the user interface presentation. Presentation of the appearance display data of the reference coating (e.g. display images) next to the modified appearance display data of the modified reference coating allows to mimic the visual comparison between the prepared sample coating and the provided reference coating in the physical world within the virtual world represented by the user interface such that the user can more easily select the appropriate display image of the modified reference which most closely resembles the appearance of the prepared sample coating.

In block 210, the routine implementing method 200 may determine if a user interface is to be generated which comprises at least one category being indicative of a visual deviation of the prepared sample coating from the provided reference coating. This determination may be made according to the programming of the routine implementing method 200 or may be based on a detected user input indicating the generation of a user interface. If it is determined in block 210 that such a user interface is to be generated, the routine implementing method 200 may proceed to block 212. Otherwise, the routine implementing method 200 may proceed to block 214.

In block 212, a user interface generation may be generated and displayed on the display, the user interface generation comprising at least one category being indicative of a visual deviation of the prepared sample coating from the provided reference coating. The at least one visual deviation of the prepared sample coating from the provided reference coating may include a deviation in lightness, a deviation in darkness, a deviation in color, a deviation in texture, a deviation in gloss and/or a deviation in clearcoat appearance. The category may be denoted with a text label indicating the type of the deviation, such as color deviation, texture deviation, gloss deviation, etc.

In block 220, modified appearance display data of the reference coating based on the data provided in block 204 or the DRR provided in block 206 may be generated. The modified appearance display data of the reference coating may be generated using the method described in the context of FIGS. 4A to 4C. The modified appearance display data may be generated by modifying at least part of the appearance data contained in the digital representation provided in block 206 or the appearance data determined in block 204 with regard to lightness, darkness, color, texture, gloss, clearcoat appearance or a combination thereof. The method of generating modified appearance display data varies and primarily depends on the type of appearance data determined in block 204 or provided in block 206.

In case said appearance data contains CIEL*a*b* or CIEL*C*h* values, modified appearance display data may be generated by modifying at least part of the CIEL*a*b* or CIEL*C*h* values using predefined color space distance values dL, da and db or dL, dC and dh, respectively. The modified CIEL*a*b* or CIEL*C*h values may be used to generate modified appearance display data as described previously. Apart from the predefined color space distance values, a well-known color tolerance equation, such as the Audi95 tolerance equation or the Audi2000 tolerance equation, may be used during modification of the appearance data. Use of a color tolerance equation may be beneficial because the color space values are weighted according to color and measurement geometry, thus allowing to achieve standardized offsets of the modified appearance display data over the whole color space.

In case the appearance data additionally contains texture images and/or texture characteristics, modified appearance display data may be generated by modifying at least part of the texture image and/or the texture characteristics using texture distance values. The modified texture characteristics may be used to generate synthetic modified texture images, for example as described in the context of FIGS. 4A to 4C below.

In case said appearance data contains RGB values, modified appearance display data may be generated by converting the RGB values into CIEL*a*b* values, modifying at least part of the CIEL*a*b* values using predefined color space distance values as described previously and optionally transforming the modified CIEL*a*b* values to modified RGB values to allow display of said data on the display of the computing device.

In block 214, a user input being indicative of selecting a category may be detected by the display or the computing device comprising the display. The user input may be used to determine which category is selected by the user in block 214. The selected category may be used in block 216 to determine modified appearance display data for this category. For example, if the user selects the category “color”, the appearance data may only be modified in block 216 such that the color of the reference coating changes to obtain display images of the modified reference coating showing a color shift, such as greener, redder, bluer, yellower, lighter, darker, more chromatic, less chromatic, positive or negative hue shift with respect to the display images of the reference coating.

In block 216, modified appearance display data of the reference coating may be generated based on the data provided in block 204 or 206 and the user input detected in block 214. The modified appearance display data of the reference coating may be generated as described in the context of FIGS. 4A to 4C. The category selected by the user in block 214 may be determined and the appearance data provided in block 204 or 206 may be modified with respect to the determined category. For example, if the user selects category “color”, the provided appearance data may be modified with respect to color, such that the color may appear greener or redder or bluer or yellower or more chromatic or less chromatic or lighter or darker or having a positive or negative hue shift. This may include modifying the CIEL*a*b* or CIEL*C*h* values as described in the context of FIGS. 4A to 4C or the RGB values as previously described. If the user selects category “texture”, a texture layer may be added as previously described or as described in to the context of FIGS. 4A to 4C below to modify the texture such that it appears coarser or finer or more sparkly or less sparkly.

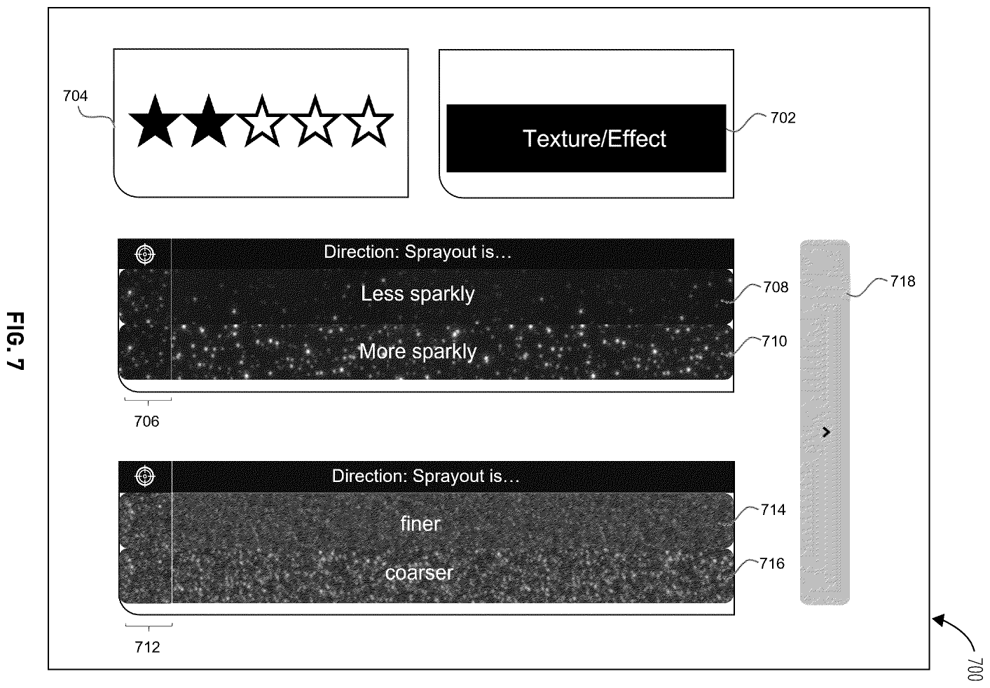

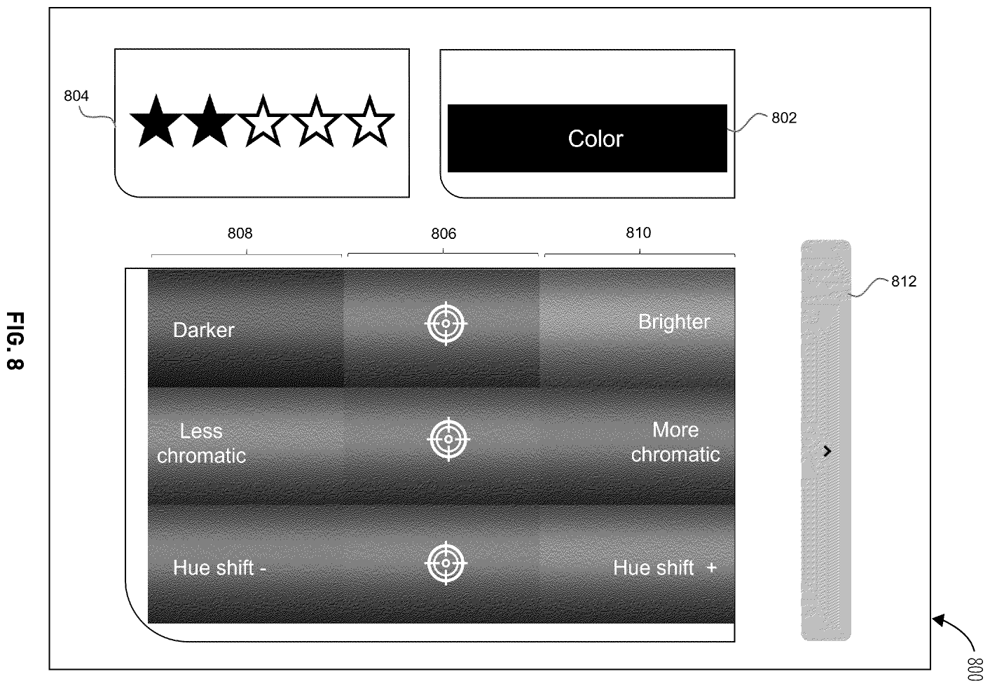

In block 218, a user interface presentation may be generated that presents the modified appearance display data generated in block 216 or 220 and optionally the display appearance data generated in block 208. The generated user interface presentation may be displayed on the display of the computing device. The user interface presentation may comprise an image of the reference coating (i.e. display appearance data of the reference coating generated in block 208) adjacent to at least one display image of the modified reference coating (i.e. modified display appearance data generated in block 216 or 220), for example as shown in FIGS. 7 and 8. The user interface presentation may comprise further icons, text, labels buttons, menus and links to improve user guidance. After then end of block 220, the routine implementing method 200 may proceed to block 104 of FIG. 1.

FIG. 3 shows an illustrative method 300 for generating appearance display data of the reference coating as described in relation to block 208 of FIG. 2. The appearance data provided in block 204 or 206 may contain CIEL*a*b* values as well as associated measurement geometries, i.e. the measurement geometries associated with the reflectance data which is used to determine said CIEL*a*b* values.

In block 302, the routine implementing method 300 may generate an ordered list of measurement geometries from the measurement geometries contained in the appearance data provided in block 204 or 206. The ordered list of measurement geometries may be generated by selecting at least one pre-defined measurement geometry from the plurality of measurement geometries provided in block 204 or 206, optionally sorting the selected measurement geometries according to at least one pre-defined sorting criterium if more than one measurement geometry is selected, and optionally calculating the accumulated delta aspecular angle for each selected measurement geometry if more than one measurement geometry is selected.

In one example, the pre-defined measurement geometry may be an intermediate measurement geometry, such as 45°. In this case, only one measurement geometry may be selected, and no sorting is required. Selection of an intermediate measurement geometry allows to generate appearance display data under diffuse illumination conditions (e.g. cloudy weather conditions).

The predefined measurement geometries may include at least one gloss geometry, such as 15 and 25° and at least one non-gloss measurement geometry, such as 45° and/or 75° and/or 110°. The selected pre-defined measurement geometries may then be sorted according to a pre-defined sorting criterium, such as a defined order of measurement geometries. For instance, a defined order of 45°>25°>15°>25°>45°>75 may be used. In another instance, a defined order of −15°>15°>25°>45°>75°>110° may be used. The pre-defined measurement geometry/geometries and/or the pre-defined sorting criterium may be retrieved from a database based on the data provided in block 204 or 206 or further data, such as the user profile, prior to generating the ordered list. After sorting the selected pre-defined measurement geometries according to the pre-defined sorting criterium, the delta aspecular angle may be calculated for each selected measurement geometry as described previously (see for example the previously listed table).

In block 304, the routine implementing method 300 may generate empty images with defined resolutions for the display images of the reference coating (e.g. the appearance display data of the reference coating). The resolution may vary greatly and generally depends on the resolution of the color and texture data acquired using a multi-angle spectrophotometer. It should be mentioned that the order of blocks 302 and 304 may also be reversed, i.e. block 304 may be performed prior to block 302.

In block 306, the routine implementing method 300 may determine whether at least one L*value included in the CIEL*a*b* values provided in block 204 or 206 is larger than 95. If it is determined in block 306 that at least one L*value of all L*values provided in block 204 or 206 is larger than 95, the routine implementing method 300 may proceed to block 308. If all provided L* values are below 95, the routine implementing method 300 may proceed to block 310.

In block 308, the routine implementing method 300 may scale all provided L* values using a lightness scaling factor s_{L} to obtain a scaled digital representation (also denoted as SDR hereinafter) or scaled appearance data. In this example, a lightness scaling factor of formula (1) may be used

$${s}_{L} = \frac{x}{{L}_{max}} \qquad ( 1 )$$

in which
x=95, and
Lₘₐₓ is the maximum L* value of the CIEL*a*b* values included in the appearance data provided in block 204 or 206.

Use of this lightness scaling factor allows to retain the color information contained in the gloss measurement geometries by compressing the color space while the existing color distances are kept constant.

In block 310, the routine implementing method 300 may generate color images of the reference coating by calculating the corresponding CIEL*a*b values for each pixel of each image generated in block 304 based on
the ordered list of measurement geometries generated in block 302 and
the CIEL*a*b* values provided in block 204 or retrieved in block 206 or the scaled digital representation generated in block 308.

The calculated CIEL*a*b* values may then be converted to sRGB values and may be stored in an internal memory of the processing device performing this block. The corresponding CIEL*a*b* values for each pixel of the generated image may be calculated by correlating one axis of each image generated in block 304 with the ordered list of measurement geometries generated in block 302 and mapping the generated ordered list of measurement geometries and associated CIEL*a*b* values or scaled CIEL*a*b* values of the reference coating to the correlated row in the respective created image. For example, the color image for the reference coating, i.e. for the CIEL*a*b* values determined and provided in block 204 or 206, may be obtained by correlating the y-axis of the image generated in block 304 with the list of measurement geometries generated in block 302 and mapping the generated ordered list of measurement geometries and associated CIEL*a*b* values provided in block 204/206 or scaled CIEL*a*b* values obtained in block 308 to the correlated row in the generated image.

In block 312, the routine implementing method 300 may determine whether a texture layer is to be added to the color image generated in block 310. This determination may be made based on the appearance data provided in block 204 or. For example, if the provided appearance data contains texture image(s) and/or texture parameters, the routine implementing method 300 may determine that a texture layer is to be added and may proceed to block 314. Otherwise, the routine implementing method 300 may proceed to block 210 of FIG. 2.

In block 314, the routine implementing method 300 may determine whether the texture image is to be generated from data provided in block 204 or 206. If the texture image is to be generated using data provided in block 204 or 206, the routine implementing method 300 may proceed to block 318. Otherwise, the routine implementing method 300 may proceed to block 316, for example if the data provided in block 204 or 206 does not include acquired texture images or texture images cannot be retrieved from a database based on the data provided in block 204 or 206.

In block 316, method 300 may generate synthetic texture image(s) by
creating an empty image having the same resolution as the image generated in block 304,
obtaining a target texture contrast cᵥ,
generating a random number by a uniform or a gaussian random number generator between −cᵥ and +cᵥ for each pixel in the created image and adding the generated random number to each pixel in the created image, and
blurring the resulting image using a blur filter, in particular a gaussian blur filter.

The target texture contrast cy may be provided by retrieving the determined coarseness and/or sparkle characteristics from data provided in block 204 or 206 and providing the retrieved coarseness and/or sparkle characteristics, in particular coarseness characteristics, as target texture contrast cᵥ. If said determined or provided data does not contain texture characteristics, the target texture contrast cᵥ may be obtained by retrieving the target texture contrast cᵥ from a database based on the data provided in block 204 or 206. The target texture contrasts cᵥ stored in the database may be obtained, for example, by associating a defined texture target contrast cᵥ with an amount or a range of amounts of aluminum pigment present in the coating formulation used to prepare the respective reference coating and retrieving the respective texture target contrast cᵥ based on the formulation data associated with said reference coating.

In block 318, method 300 may generate the texture image from the respective acquired texture image(s), in particular the texture image acquired at a measurement geometry of 15°, by retrieving said texture images from the data provided in block 204 or 206 or by retrieving the respective acquired texture image, in particular the texture image acquired at a measurement geometry of 15°, from a data storage medium based on the data provided in block 204 or 206.

In block 320, method 300 may generate modified texture images for each acquired or synthetic texture image provided in block 316 or 318 by computing the average color of each acquired or synthetic texture image provided in block 316 or 318 and subtracting the computed average color from the respective provided acquired or synthetic texture image. The average color of each provided acquired or synthetic texture image may be computed by adding up all pixel colors of the provided acquired or synthetic texture image and dividing this sum by the number of pixels of the provided acquired or synthetic texture image or by computing the pixel-wise local average color.

In block 322, method 300 may generate appearance display data of the reference coating by adding the respective modified texture image generated in block 320 pixel-wise weighted with a lightness scaling factor s_{L} and an aspecular-dependent scaling function sf_{aspecular} to the respective color image generated in block 310. The aspecular dependent scaling function weights each pixel of the texture layer in correlation with the aspecular angles corresponding to the measurement geometries present in generated ordered list of measurement geometries. This allows to weight the pixels of the texture layer in correlation with the visual impression of the effect coating layer when viewed by an observer under different measurement geometries and therefore results in generated appearance data closely resembling the visual impression of the effect coating when viewed under real-world conditions.

One of the following aspecular dependent scaling functions (2a) and (2b) may be used

$${sf}_{aspecular} = \frac{( {aspecular}_{max} - aspecula )}{{aspecular}_{max}} \qquad ( 2 a )$$

$${sf}_{aspecular} = {( \frac{( {aspecular}_{max} - aspecula )}{{aspecular}_{max}} )}^{2} \qquad ( 2 b )$$

in which
aspecularₘₐₓ is the measurement geometry in the ordered list corresponding to the highest aspecular angle, and
aspecular is the respective measurement geometry of a pixel of the texture layer or
the value of the aspecular-dependent scaling function sf_{aspecular} is set to 1 if the ordered list generated in block 302 includes only one measurement geometry or does not include any gloss and flop measurement geometries.

The lightness scaling factor s_{L} used in block 322 may correspond to the lightness scaling factor s_{L} used in block 308, i.e. the same lightness scaling factor s_{L} may be used in blocks 308 and 322, or may be 1 in case no lightness scaling factor s_{L} used (i.e. block 308 is not performed). Use of the same lightness scaling factor s_{L} in block 322 allows to adjust the lightness of the texture image to the lightness of the color image, thus preventing a mismatch of the color and texture information with respect to lightness.

The addition may be performed according to formula (3)

$$AI ( X , Y ) = CI ( X , Y ) + {s}_{L} * {s}_{c} * s {f}_{aspecular} * modified TI ( X , Y ) \qquad ( 3 )$$

in which
AI (X, Y) is the image resulting from addition of the texture layer to the respective generated color image,
CI (X, Y) is the generated color image,
s_{L} corresponds to the lightness scaling factor used to generate the respective color image or is 1 in case no lightness scaling factor is used to generate the respective color image,
s_{c} is the contrast scaling factor and is set to 1,
sf_{aspecular} is the aspecular-dependent scaling function, and
modified TI (X, Y) is the modified texture image.

FIGS. 4A to 4C show an illustrative method 400 for generating modified appearance display data as described in relation to block 216 or 220 of FIG. 2. The appearance data to be modified (i.e. the data provided in block 204 or 206 of FIG. 2) may contain CIEL*a*b* values determined at a plurality of measurement geometries as well as associated measurement geometries, i.e. the measurement geometries associated with the reflectance data which is used to determine said CIEL*a*b* values.

In block 402, the routine implementing method 400 may determine whether a user input has been detected, i.e. whether the user has selected a category as described in relation to blocks 212 and 214 of FIG. 2. If a user input has been detected, the routine implementing method 400 may proceed to block 404, otherwise it may proceed to block 406 described later on.

In block 404, the routine implementing method 400 may generate modified appearance data based on the appearance data provided in block 204 or block 206 of FIG. 2 and the user input detected in block 214 of FIG. 2. Modified appearance data may be generated by modifying the provided appearance data using predefined color space distance values dL, da and db and/or texture distance values as described in relation to block 216 of FIG. 2 depending on the category selected by the user in block 214. The modified appearance data may be generated by modifying the provided/retrieved appearance data using predefined color space distance values dL, da and db, a well-known color tolerance equation, such as the Audi95 or Audi2000 color tolerance equation, and/or texture distance values as described in relation to block 216 of FIG. 2 depending on the category selected by the user in block 214. Use of the Audi95 or Audi2000 color tolerance equation may be beneficial because the color space values are weighted according to color and measurement geometry, thus allowing to achieve standardized offsets of the modified appearance data from the appearance data of the reference coating over the whole color space.

In block 406, the routine implementing method 400 may generate modified appearance data based on the appearance data provided in block 204 or block 206 of FIG. 2. The modified appearance data may be generated as described in relation to block 404 without considering the user input. All appearance data provided in blocks 204 or 206 of FIG. 3 may be modified. Only part of the appearance data provided in block 204 or 206 of FIG. 2 may be modified based on predefined rules, for example based on appearance data of the reference coating.

In block 408, an ordered list of measurement geometries may be generated. Generation of the ordered list of measurement geometries may be performed as described in to the context of block 302 of FIG. 3. The same ordered list of measurement geometries may be generated as in block 302 of FIG. 3 to allow comparison of the appearance display data associated with the reference coating with the modified appearance display data because each line in the displayed data (e.g. the display images of modified reference and the reference coatings) belongs to the same measurement geometry (e.g. the same aspecular angle) if the generated appearance data is presented side by side in a horizontal arrangement in the user interface presentation.

In block 410, the routine implementing method 400 may generate image(s) with defined resolutions. The same resolution as in block 304 of FIG. 3 may be used to obtain display images having the same size as the display images of the reference coating. Use of the same resolution allows to easily compare the display image(s) of the reference coating with the display image(s) of the modified reference coating. In another example, a different resolution is used to obtain larger or smaller display images than the display images of the reference coating.

In block 412, the routine implementing method 400 may determine whether at least one L*value included in the modified CIEL*a*b* values generated in block 404 or block 406 is larger than 95 and whether block 308 of FIG. 3 described previously has been performed. If it is determined in block 412 that at least one L*value of all modified L*values generated in block 404 or 406 is higher than 95 and block 308 of FIG. 3 has been performed, the routine implementing method 400 may proceed to block 414. If all provided L* values are below 95 and block 308 of FIG. 3 has not been performed, the routine implementing method 400 may proceed to block 416.

In block 414, the routine implementing method 400 may scale all modified L* values using a lightness scaling factor s_{L} to obtain scaled modified appearance data (denoted as SMAP). The lightness scaling factor of formula (1) as described in relation to block 308 of FIG. 3 may be used. With preference, the same scaling factor si may be used as in block 308 of FIG. 3 to avoid differences in lightness due to the use of different lightness scaling factors.

In block 416, the routine implementing method 400 may generate color image(s) of the modified reference coating as described in relation to block 310 of FIG. 3 by calculating the corresponding CIEL*a*b values for each pixel of each image generated in block 410 based on
the ordered list of measurement geometries generated in block 408 and
the modified CIEL*a*b* values generated in block 404 or block 406 or the scaled modified appearance data generated in block 414.

In block 418, the routine implementing method 400 may determine whether a texture and/or clearcoat appearance layer is to be added to the color image generated in block 416. This determination may be made based on the provided appearance data or the modified appearance data. For example, if the provided or modified appearance data contains texture image(s) and/or texture parameters, the routine implementing method 400 may determine that a texture layer is to be added and may proceed to block 422. In case no texture and clearcoat appearance layer is to be added, the routine implementing method 400 may proceed to block 218 of FIG. 2. This may be, for example, the case if the reference and modified reference coating is a solid or straight shade coating not comprising any effect pigments and thus not having any visual texture. In case only a clearcoat appearance layer is to be added, for example if the clearcoat appearance of a solid shade coating is to be modified, the routine implementing method 400 may proceed to block 420.

In block 420 (see FIG. 4B), the routine implementing method 400 may determine whether a texture image is to be generated from the provided data (i.e. data provided in block 204 or 206 of FIG. 2) or the modified data (i.e. the modified appearance data generated in block 404 or 406). If the texture image is to be generated using provided or modified data, the routine implementing method 400 may proceed to block 422. Otherwise, the routine implementing method 400 may proceed to block 424, for example if the provided or modified data does not include acquired texture images or texture images cannot be retrieved from a database based on the provided or modified data.

In block 422, the routine implementing method 400 may generates the texture image from the respective texture image(s), in particular the texture image acquired at a measurement geometry of 15°, by retrieving said texture images from the provided or modified data or by retrieving the respective texture image, in particular the texture image acquired at a measurement geometry of 15°, from a data storage medium based on the provided or modified data. The texture images may be generated as described in the context of FIG. 3.

In block 424, the routine implementing method 400 may generate synthetic texture image(s) as described in relation to block 316 of FIG. 3.

In block 426, the routine implementing method 400 may generate modified texture images for each texture image generated in block 422 or 424 by computing the average color of each texture image provided in block 422 or 424 and subtracting the computed average color from the respective provided acquired or synthetic texture image as described in relation to block 320 of FIG. 3.

In block 428, the routine implementing method 400 may determine whether the texture contrast is to be scaled, for example by using a texture scaling factor during generation of the modified appearance display data. This determination may be made according to the programming and may be based on the type of effect pigments present in the reference coating formulation, the modifications to be displayed with respect to the texture, etc., In case the routine implementing method 400 determines that the texture contrast is to be scaled, it may proceed to block 430. Otherwise, it may proceed to block 432 described later on.

In block 430, the routine implementing method 400 may add the respective modified texture image generated in block 426 pixel-wise weighted with a lightness scaling factor s_{L} an aspecular-dependent scaling function sf_{aspecular} and a texture contrast scaling factor s_{c} to the respective color image generated in block 416 as described in relation to block 322 of FIG. 3 with the exception, that the texture contrast scaling factor s_{c} is set to values of more or less than 1. With preference, the same lightness scaling factor s_{L} as used in block 308 of FIG. 3 and block 414 may be used. Moreover, the same aspecular-dependent scaling function sf_{aspecular} as used in block 322 of FIG. 3 may be used in block 430. The use of the texture contrast scaling factor s_{c} allows to scale the contrast of the texture to visualize color differences by setting the value of the texture contrast scaling factor to values of more than 1 (to obtain a higher texture contrast) or to lower than 1 (to obtain a lower texture contrast).

In block 432, the routine implementing method 400 may add the respective modified texture image generated in block 426 pixel-wise weighted with a lightness scaling factor s_{L} and an aspecular-dependent scaling function sf_{aspecular} to the respective color image generated in block 416 as described in relation to block 322 of FIG. 3 and block 430 of FIG. 4.

In block 434, the routine implementing method 400 may determine whether a clearcoat appearance layer is to be added to the image generated in block 430 or 432. This determination may be made according to the user input detected in block 214 of FIG. 2 or according to the programming and may be based, for example, on modifications to be displayed with respect to the clearcoat appearance. If the routine implementing method 400 determines in block 434 that an appearance layer is to be added, it may proceed to block 436. Otherwise, it may proceed to block 218 of FIG. 2.

In block 436, the routine implementing method 400 generates modified appearance display data by retrieving a clearcoat appearance image or layer, for example from a database, and adding the retrieved image or layer pixel-wise to the image obtained in block 430 or 432. Afterwards, the routine implementing method 400 proceeds to block 218 of FIG. 2.

In block 438 (see FIG. 4C), the routine implementing method 400 may generate modified appearance display data by retrieving a clearcoat appearance image or layer, for example from a database, and adding the retrieved image or layer pixel-wise to the color image generated in block 416, for example as described in the context of FIG. 3. Afterwards, the routine implementing method 400 may proceed to block 218 of FIG. 2.

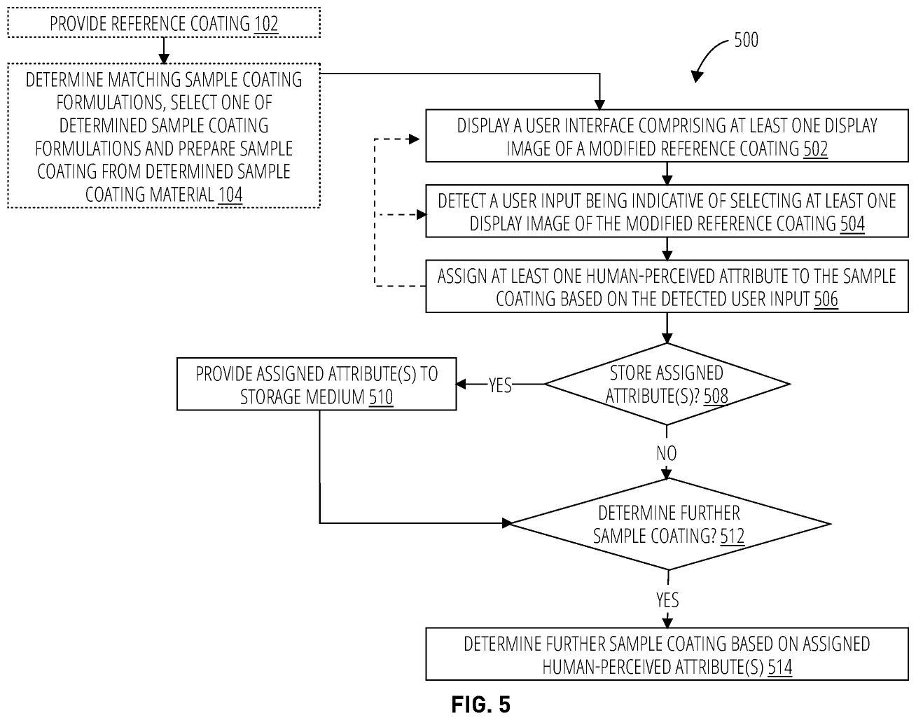

FIG. 5 depicts a second non-limiting embodiment of a computer-implemented method 500 for assigning at least one human-perceived or visually perceived attribute to a sample coating, said method being implemented by a computing device comprising a computer processor and a display, such as the computing device described in the context of FIG. 6. The computing device may comprise the display and may be a mobile device having an LCD display, such as a tablet or laptop. The computing device may be a stationary device, such as a stationary computer being attached to a peripheral display, such as an LCD screen. The reference coating and the sample coating may be effect coatings comprising effect pigment(s). The reference coating and the effect coating may be solid shade coatings comprising color pigments but being free of effect pigments. The sample coating may be prepared from a provided reference coating as described in the context of FIG. 1. Blocks 502 to 506 of FIG. 5 may correspond to blocks 106 to 110 of FIG. 1. The user interface displayed in block 502 may be generated with the methods described in relation to FIGS. 2 to 4C above. In addition, method 500 may comprise further blocks 508 to 514 explained in more detail below.

In block 508, the routine implementing method 500 may determine whether the user wants to store the human-perceived attributes assigned to the sample coating in block 506. For this purpose, the routine may generate and display a graphical user interface presentation containing a respective menu or selection which allows the user to indicate that he desires to store the assigned human-perceived attributes. If the routine determines that the user wants to store the human-perceived attributes assigned in block 506, it may proceed to block 510. Otherwise, it may proceed to block 512 described later on.

In block 510, the human-perceived attributes assigned in block 506 may be provided by the routine to a data storage medium. Prior to providing said attributes, the assigned human-perceived attributes may be displayed to the user and the user may select which attributes he wants to store on the data storage medium. The data storage medium may be an internal memory of the computing device, or a database connected via a communication interface with the computing device. The graphical user interface presentation may include a menu allowing the user to determine the desired storage location and to assign a name to the attributes to be stored. In this example, the assigned attributes are interrelated with a unique ID and optionally data being indicative of the sample coating. This allows to retrieve said data from the data storage medium using the unique ID or data being indicative of the sample coating.

In block 512, the routine may determine whether a further sample coating is to be determined based on the human-perceived attributes assigned in block 506. This determination may be made, for example, by generating and displaying a graphical interface presentation containing a respective menu or selection which allows the user to indicate that a further sample coating is to be determined.

Determination of the further sample coating may be performed by
calculating an adjusted sample coating using a color adjustment process, and
determining whether the adjusted sample coating improves at least one, in particular all, human-perceived attributes assigned in block 506.

A suitable color adjustment process to calculate an adjusted sample coating is, for example, described in EP 2149038 B1. Determination of the adjusted sample coating may be performed completely or at least partly with the processor of the computing device or with a further processor being present separate for the computing device. For example, a further processor being present separate from the processor of the computing device may be used to calculate the adjusted sample coating while the processor of the computing device determines whether the adjusted sample coating improves the human-perceived attribute. To allow data exchange, both processors may be connected via a communication interface. Shifting the calculation of the adjusted sample coating to a further processor allows to use computing devices having lower computing power as compared to performing the calculation of the adjusted sample coating with the processor of the computing device.

Determining whether the adjusted sample coating improves at least one, in particular all, assigned human-perceived attributes may be performed by
calculating the color data of the adjusted sample coating,
determining—for each determined human-perceived attribute—the difference between the adjusted sample coating and the reference coating as well as the difference between the sample coating and the reference coating based on the provided digital representations of the adjusted sample coating, the sample coating and the reference coating, and
determining—for each determined human-perceived attribute—if the difference between the adjusted sample coating and the reference coating is less than the difference between the sample coating and the reference coating.

If the adjusted sample-coating does not improve at least one, in particular all, human-perceived attributes, a list of matching sample coatings retrieved by performing a database search may be displayed to the user. If the adjusted sample coating does improve at least one, in particular all, human-perceived attributes, the formulation of the adjusted sample coating may be displayed to the user. Using the human-perceived attributes assigned to the sample coating to determine whether the adjusted sample coating improves said attributes allows to provide adjusted sample coatings more accurately matching the visual appearance of the reference coating than the sample coating.

FIG. 6 shows a computing device 600 with a display that may be used to implement any aspect of the methods set forth in the above-described FIGS. 1 to 5. In all cases, the computing device 600 represents a physical and tangible processing mechanism. The computing device 600 may be a portable device, such as a tablet, smartphone, laptop etc. or a stationary device such as a desktop computer.

The computing device 600 may include one or more hardware processors 602. The hardware processor(s) may include, without limitation, one or more Central Processing Units (CPUs), and/or one or more Graphics Processing Units (GPUs), and/or one or more Application Specific Integrated Circuits (ASICs), etc. More generally, any hardware processor may correspond to a general-purpose processing unit or an application-specific processor unit.

The computing device 600 may also include computer-readable storage media 604, corresponding to one or more computer-readable media hardware units. The computer-readable storage media 604 may retain any kind of information 606, such as machine-readable instructions, settings, data, etc. Without limitation, for instance, the computer-readable storage media 604 may include one or more solid-state devices, one or more magnetic hard disks, one or more optical disks, magnetic tape, and so on. Any instance of the computer-readable storage media 604 may use any technology for storing and retrieving information. Further, any instance of the computer-readable storage media 604 may represent a fixed or removable component of the computing device 600. Further, any instance of the computer-readable storage media 604 may provide volatile or non-volatile retention of information.

The computing device 600 may utilize any instance of the computer-readable storage media 604 in different ways. For example, any instance of the computer-readable storage media 604 may represent a hardware memory unit (such as Random Access Memory (RAM)) for storing transient information during execution of a program by the computing device 600, and/or a hardware storage unit (such as a hard disk) for retaining/archiving information on a more permanent basis. In the latter case, the computing device 600 may also include one or more drive mechanisms 608 (such as a hard drive mechanism) for storing and retrieving information from an instance of the computer-readable storage media 604.

The computing device 600 may perform any of the functions described above when the hardware processor(s) 602 carry out computer-readable instructions stored in any instance of the computer-readable storage media 604. For instance, the computing device 600 may carry out computer-readable instructions to perform each block of the methods described in Part FIGS. 1 to 5.

Alternatively, or in addition, the computing device 600 may rely on one or more other hardware logic components 610 to perform operations using a task-specific collection of logic gates. For instance, the hardware logic component(s) 610 may include a fixed configuration of hardware logic gates, e.g., that are created and set at the time of manufacture, and thereafter unalterable. Alternatively, or in addition, the other hardware logic component(s) 610 may include a collection of programmable hardware logic gates that can be set to perform different application-specific tasks. The latter category of devices may include, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 6 generally indicates that hardware logic circuitry 612 includes any combination of the hardware processor(s) 602, the computer-readable storage media 604, and/or the other hardware logic component(s) 610. That is, the computing device 600 may employ any combination of the hardware processor(s) 602 that execute machine-readable instructions provided in the computer-readable storage media 604, and/or one or more other hardware logic component(s) 610 that perform operations using a fixed and/or programmable collection of hardware logic gates. More generally stated, the hardware logic circuitry 612 corresponds to one or more hardware logic components of any type(s) that perform operations based on logic stored in and/or otherwise embodied in the hardware logic component(s).

The computing device 600 may also include an input/output interface 614 for receiving various inputs (via input devices 616), and for providing various outputs (via display device 618 comprising GUI 200). The display device 618 may be used to display the display image(s) of the modified reference coating and optionally the reference coating while the input device 614 may be used to provide the user input being indicative of selecting at least one display image of the modified reference coating and further inputs described above. Illustrative input devices may include a keyboard device, a mouse input device, a touchscreen input device and/or a digitizing pad. The display device 618 may correspond to a liquid crystal display device, a light-emitting diode display (LED) device, a cathode ray tube device, a projection mechanism, etc. Other output devices (not shown) may include a printer, one or more speakers, a haptic output mechanism, an archival mechanism (for storing output information), and so on.

The computing device 600 may also include one or more network interfaces 622 for exchanging data with other devices via one or more communication conduits 624. The communication conduit(s) 624 may be implemented in any manner, e.g., by a local area computer network, a wide area computer network (e.g., the Internet), point-to-point connections, etc., or any combination thereof. The communication conduit(s) 624 may include any combination of hardwired links, wireless links, routers, gateway functionality, name servers, etc., governed by any protocol or combination of protocols. Other devices may include measurement device(s), such as RGB cameras, single-angle or multi-angle spectrophotometers, databases or a combination thereof.

One or more communication buses 626 may communicatively couple the above-described components together.

FIG. 6 shows the computing device 600 as being composed of a discrete collection of separate units. In some cases, the collection of units may correspond to discrete hardware units provided in a computing device chassis having any form factor. FIG. 6 shows illustrative form factors in its bottom portion.

FIG. 7 shows an illustrative user interface presentation 700 produced by the computing device, for example the computing device of FIG. 6, performing the methods described in FIGS. 1 and 5 and displayed on the display of the computing system. The user interface presentation may be generated according to the method described in FIGS. 2 to 4C. In this non-limiting case, the presentation 700 may indicate the category 702 of the modification of the provided effect reference coating. In this example, the texture/effect of the provided reference effect coating was modified. The category may be selected by the user as described in relation to FIG. 2 above. The user interface presentation 700 may further display an overall rating 704 of the prepared sample effect coating. The overall rating may be defined by the user by selecting the appropriate number of stars, for example by clicking on each star.

The user interface presentation 700 may further comprise a set of display images of the provided reference effect coating 706, 712 and associated modified reference effect coatings 708, 710, 714, 716. In this example, two different reference effect coatings 706, 712 are displayed. In another example, only one reference effect coating may be displayed. Adjacent to each reference effect coating 706, 712, display images of modified reference effect coatings 708, 710, 714, 716 may be displayed which have been generated by modifying the texture of the reference effect coating with respect to the sparkling grade and the coarseness. In this example, the display images of the reference effect coating were generated according to the method of FIG. 3 and the display images of the modified reference effect coating were generated according to the method of FIGS. 4A and 4B (without addition of an appearance layer). A label may be displayed on each display image of the modified reference effect coating to indicate the modification performed with respect to the reference effect coating. This allows to increase user comfort during selection of the display image of the modified reference effect coating, which most closely resembles the prepared sample effect coating.

The user interface presentation 700 may also include a button 718 which allows to the user to return to the previous menu, for example to select a different category.

The user interface presentation 700 may further include a comment field (not shown) and/or further buttons, icons, menus.

FIG. 8 shows an illustrative user interface presentation 800 produced by the computing device, for example the computing device of FIG. 6, performing the methods described in FIGS. 1 and 5 and displayed on the display of the computing system. The user interface presentation may be generated according to the method described in FIGS. 2 to 4C. In this non-limiting case, the presentation 800 may indicate the category 802 of the modification of the provided reference coating. In this example, the color of the reference coating was modified. The category may be selected by the user as described in relation to FIG. 2 above. The user interface presentation 800 may further display an overall rating 804 of the sample coating. The overall rating may be defined by the user by selecting the appropriate number of stars, for example by clicking on each star.

The user interface presentation 800 may further comprise a set of display images of a provided reference coating 806 and two sets of associated modified reference coatings 808, 810. The set of display images of the provided reference coatings 806 may be displayed in the middle while each set of display images of the modified reference coating 808, 810 may be displayed adjacent to the set of display images of the provided reference coating 806. The display images of the provided reference coating may be generated according to the method of FIG. 3 and the display images of the modified reference coating may be generated according to the method of FIG. 4A. The reference coating may be modified with respect to darkness/brightness and chroma and hue shift. The color of the reference coating may be modified to appear greener and/or yellower and/or redder and/or bluer (not shown). A label may be displayed on each display image of the modified reference coating to indicate the modification performed with respect to the reference coating.

The user interface presentation 800 may also include a button 812 which allows to the user to return to the previous menu, for example to select a different category.

The user interface presentation 800 may further include a comment field (not shown) and/or further buttons, icons, menus.

Use of the user interface presentation of FIGS. 7 and 8 greatly facilitates appropriate determination of the visual deviation of the prepared sample coating from the provided reference coating because the possible color deviations of the provided reference coating from the prepared sample coating are displayed within the graphical user representation, thus allowing the user to easily select the display image of the modified reference coating with most closely resembles the appearance of the sample coating without requiring any knowledge about coloristics, as would be the case if the user would have to select a verbal description of the color deviation or describe the observed color deviation in his own words.

The present disclosure has been described in conjunction with a preferred embodiment as examples as well. However, other variations can be understood and effected by those persons skilled in the art and practicing the claimed invention, from the studies of the drawings, this disclosure and the claims. Notably, it is not required that the different steps are performed at a certain place or at one node of a distributed system, i.e. each of the steps may be performed at a different nodes using different equipment/data processing units.

In the claims as well as in the description the word “comprising” or “including” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for assigning at least one human-perceived attribute to a sample coating based on a visual evaluation of the sample coating with respect to a reference coating, said method comprising at a computing device with a display:
(i) displaying on the display a user interface comprising at least one display image of a modified reference coating; and
(ii) detecting with the computing device a user input being indicative of selecting at least one display image of the modified reference coating, wherein the user input is associated with the visual evaluation of the sample coating with respect to the reference coating; and
(iii) in response to the detected user input, assigning with the computing device at least one human-perceived attribute to the sample coating.

2. The method according to claim 1, wherein the human-perceived attribute indicates a deviation of the sample coating from the reference coating.

3. The method according to claim 1, wherein the display image of the modified reference coating is modified with respect to the lightness and/or darkness and/or color and/or texture and/or gloss and/or clearcoat appearance as compared to a display image of the reference coating.

4. The method according to claim 1, wherein step (i) comprises
(i-1) providing via a communication interface to the processor of the computing device a digital representation of the reference coating including appearance data determined at one or more measurement geometries;
(i-2) generating with the processor modified appearance data of the reference coating based on the provided digital representation; and
(i-3) generating a user interface presentation that presents the modified appearance data generated in step (i-2) as display image(s) of the modified reference coating and displaying the generated user interface presentation.

5. The method according to claim 4, wherein the appearance data includes reflectance data, color data, gloss data, texture parameters, texture images, shortwave values, longwave values, DOI values or a combination thereof.

6. The method according to claim 4, wherein generating modified appearance data includes modifying at least part of the appearance data of the provided digital representation with regard to lightness, darkness, color, texture, gloss, clearcoat appearance or a combination thereof.

7. The method according to claim 4, wherein step (i-2) further includes:
generating a color image by calculating corresponding color data for each pixel in the created image based on
an ordered list of measurement geometries generated from the digital representation provided in step (i-1) and
the generated modified appearance data, or if at least one L*value included in the modified appearance data is greater than 90, scaled modified appearance data and
optionally adding a texture layer pixel-wise to each generated color image using a lightness scaling factor s_{L}, an aspecular-dependent scaling function sf_{aspecular} and optionally a texture contrast scaling factor s_{c}.

8. The method according to claim 4, further comprising a step of generating with the processor appearance data of the reference coating based on the provided digital representation and presenting the generated appearance data as display image of the reference coating.

9. The method according to claim 4, wherein the modified appearance data of the reference coating is generated based on the provided digital representation and a user input being indicative of selecting at least one category being indicative of a visual deviation of the sample coating from the reference coating, wherein the user input is detected by displaying a user interface comprising the at least one category.

10. The method according to claim 1, wherein step (i) further includes displaying a label for at least part of the display images of the modified reference coatings, said label being indicative of the modification of the reference coating with regard to lightness or darkness or color or texture or gloss or clearcoat appearance.

11. The method according to claim 1, wherein step (i) further includes displaying at least one display image of the reference coating of the modified reference coatings.

12. The method according to claim 1, wherein steps (i) to (iii) or steps (ii) and (iii) are repeated at least once.

13. The method according to claim 1, wherein assigning at least one human-perceived attribute to the sample coating in response to the detected user input includes mapping deviation(s) associated with the detected user input to respective human-perceived attribute(s).

14. An apparatus for assigning at least one human-perceived attribute to a sample coating, the apparatus comprising: a display; one or more computing nodes; and one or more computer-readable media having thereon computer-executable instructions that are structured such that, when executed by the one or more computing nodes, cause the apparatus to perform the method of claim 1.

15. A computer program element with instructions, which, when executed by a computing device is configured to carry out the steps of the method according to claim 1.

16. The method according to claim 5, wherein the color data comprises CIEL*a*b* values, CIEL*C*h* values or RGB values.

17. The method according to claim 5, wherein texture parameters correspond to sparkle characteristics and/or coarseness characteristics.

18. The method according to claim 6, wherein modifying at least part of the appearance data comprises using predefined color space distance values and/or texture distance values or comprises adding a predefined appearance layer to at least part of the appearance data.

19. The method according to claim 1, wherein step (i) further comprises adjacent to at least part of the display images of the modified reference coatings.

20. A computer program element with instructions, which, when executed by a computing device of a computing environment is configured to carry out the steps of the method as provided by the apparatus of claim 14.
